(19) United States
(12) Patent Application Publication
(10) Pub. No.: US 2025/0193125 A1
(43) Pub. Date: Jun. 12, 2025

(54) DATA TRANSFER DEVICE AND METHOD

(71) Applicant: KABUSHIKI KAISHA TOSHIBA, Tokyo (JP)

(72) Inventors: Yuta KOBAYASHI, Ota (JP); Takahiro YAMAURA, Kawasaki (JP)

(73) Assignee: KABUSHIKI KAISHA TOSHIBA, Tokyo (JP)

(21) Appl. No.: 18/789,779

(22) Filed: Jul. 31, 2024

(30) Foreign Application Priority Data
Dec. 11, 2023 (JP) 2023-208421

(51) Int. Cl. H04L 47/56; H04L 43/0852; H04L 47/24; H04L 47/2416

(52) U.S. Cl. CPC H04L 47/56; H04L 43/0852; H04L 47/2416; H04L 47/245

(57) ABSTRACT

According to one embodiment, a data transfer device is configured to sequentially transfer data with specified priority and includes an issuing unit and a controller. The issuing unit is configured to issue a first request to transfer first data via a first interface. The controller is configured to stop issuing a second request to transfer second data after the first data, while a period required after an input of a response to the first request is started and until the input is completed, when the first request is issued.

### CROSS-REFERENCE TO RELATED APPLICATIONS

This application is based upon and claims the benefit of priority from Japanese Patent Application No. 2023-208421, filed Dec. 11, 2023, the entire contents of which are incorporated herein by reference.

### FIELD

Embodiments described herein relate generally to a data transfer device and method.

### BACKGROUND

In recent years, Ethernet (registered trademark) has been increasingly used in industrial networks that connect industrial devices in factories, in-vehicle networks that connect control controllers in automobiles, and the like.

Since high real-time performance is required for such industrial networks and in-vehicle networks, various real-time Ethernet standards have been proposed.

In general, for example, data from a host device is transmitted to the network via a network interface card (NIC) in a communication device that constitutes a communication system, but the processing between the NIC and the network (network processing) is specified in the real-time Ethernet standards.

When a communication system is actually constructed, however, the high real-time performance in communication over a network (i.e., low delay in communication) may not be able to be realized unless the processing between the host device and the NIC is also considered in addition to the above-described network processing.

### BRIEF DESCRIPTION OF THE DRAWINGS

FIG. 1 is a diagram showing an example of a configuration of a communication device according to a comparative example of a first embodiment.

FIG. 2 is a flowchart showing an example of a procedure of a communication device according to a comparative example of the first embodiment.

FIG. 3 is a chart illustrating a processing time of a data transfer device according to a comparative example of the embodiment.

FIG. 4 is a chart illustrating an example of a delay that occurs in a situation where a plurality of requests are issued sequentially to transfer transmit data of different priorities.

FIG. 5 is a diagram showing an example of a configuration of a communication device in the present embodiment.

FIG. 6 is a diagram illustrating an example of an operation of a DTC delay control unit.

FIG. 7 is a chart illustrating a low delay realized in the present embodiment.

FIG. 8 is a chart illustrating a processing time of a data transfer device according to a comparative example of a second embodiment.

FIG. 9 is a chart illustrating an example of a delay that occurs in a situation where transmit data of different priorities is transferred sequentially.

FIG. 10 is a diagram showing an example of a configuration of a communication device in the present embodiment.

FIG. 11 is a diagram illustrating an outline of window values held in a window control unit.

FIG. 12 is a diagram illustrating an example of an operation of a window control unit.

FIG. 13 is a chart illustrating a low delay realized in the present embodiment.

FIG. 14 is a diagram illustrating an example of an operation of the window control unit in a case where a DTC delay control unit is omitted.

FIG. 15 is a diagram showing an example of a configuration of a communication device according to a third embodiment.

FIG. 16 is a chart illustrating an example of operations of the window control unit and a gate status check unit.

FIG. 17 is a chart illustrating an example of operations of the window control unit and the gate status check unit.

FIG. 18 is a diagram showing a configuration example of a system using the communication device according to each of the embodiments.

### DETAILED DESCRIPTION

In general, according to one embodiment, a data transfer device is configured to sequentially transfer data with specified priority, and includes an issuing unit and a controller. The issuing unit is configured to issue a first request to transfer first data via a first interface. The controller is configured to stop issuing a second request to transfer second data after the first data, while a period required after an input of a response to the first request via the first interface is started and until the input is completed elapses, when the first request is issued.

Various embodiments will be described with reference to the accompanying drawings.

### First Embodiment

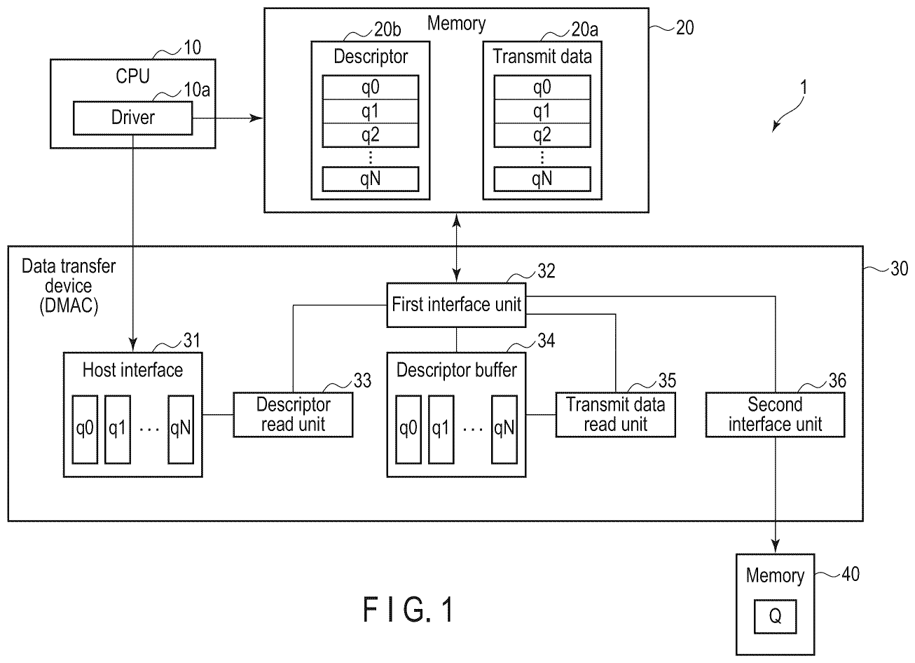

First, a first embodiment will be described. FIG. 1 shows an example of a configuration of a communication device according to a comparative example of the present embodiment. Incidentally, a communication device 1 shown in FIG. 1 is assumed to be, for example, a device such as a personal computer (PC), a server device, a dedicated large-scale integration (LSI) or a field programmable gate array (FPGA), but may also be the other device.

As shown in FIG. 1, the communication device 1 comprises a CPU 10, a memory 20, a data transfer device 30, a memory 40, and the like.

The CPU 10 and the memory 20 constitute a host device. The CPU 10 (host processor) is connected to a memory (hereinafter referred to as a host side memory) 20 via a memory controller in the CPU 10. The CPU 10 executes various application programs loaded into the host side memory 20. In the present embodiment, data to be transmitted from the communication device 1 to an external device via a network (hereinafter referred to as transmit data) is assumed to be generated by executing the application programs by the CPU 10.

Incidentally, the above transmit data and descriptors in which information on the transmit data are described are written to the host side memory 20 by a driver 10a which runs on the CPU 10. The descriptor includes, for example, a data length (size) of the transmit data, an address of the host side memory 20 to which the transmit data is written, and the like.

The host side memory 20 includes an area where the transmit data is written (hereinafter referred to as a transmit data area) 20a and an area where the descriptors are written (hereinafter referred to as a descriptor area) 20b. In the present embodiment, a predetermined priority for the transmit data is specified by the above-described application program, and the transmit data area 20a and the descriptor area 20b have a plurality of queues corresponding to the priority (i.e., a plurality of queues to which the priorities are assigned). In the example shown in FIG. 1, the transmit data area 20a and descriptor area 20b have queues q0 to qN.

In the present embodiment, the host side memory 20 is realized by, for example, a static random access memory (SRAM), a dynamic random access memory (DRAM), a synchronous dynamic random access memory (SDRAM), or the like.

The data transfer device 30 corresponds to, for example a direct memory access controller (DMAC), and has a function of sequentially transferring the data written to the above-described host side memory 20 (i.e., the transmit data area 20a).

As shown in FIG. 1, the data transfer device 30 includes a host interface 31, a first interface unit 32, a descriptor read unit 33, a descriptor buffer 34, a transmit data read unit 35, and a second interface unit 36.

The host interface 31 is an interface for connecting the data transfer device 30 with the CPU 10 (i.e., the driver 10a). The host interface 31 has register areas for holding information for accessing the queues q0 to qN corresponding to the above-described priorities. The descriptor information is stored based on a transfer request issued by the driver 10a when the above-described transmit data is generated, in the register areas corresponding to the queues q0 to qN of the host interface 31.

The first interface unit 32 is an interface for connecting the data transfer device 30 to the host side memory 20 and is provided to realize a DMA process.

The descriptor read unit 33 issues a descriptor request to read a descriptor from the host side memory 20 (i.e., descriptor area 20b) (i.e., a request requesting the descriptor), based on the descriptor information stored in the queues q0 to qN in the host interface 31. The descriptor request issued by the descriptor read unit 33 includes the address, data length (size), and the like of the descriptor to be read out based on descriptor request and is output to the host side memory 20 via the first interface unit 32.

The descriptors read from the descriptor area 20b based on the descriptor request output to the host side memory 20 as described above are input to the data transfer device 30 via the first interface unit 32. The descriptors thus input to the data transfer device 30 are stored in the descriptor buffer 34. Incidentally, the descriptor buffer 34 includes the queues q0 to qN corresponding to the above-described priorities.

The transmit data read unit 35 issues a transmit data request to read transmit data from the host side memory 20 (i.e., the transmit data area 20a) (i.e., a request requesting the transmit data) based on the descriptors stored in the queues q0 to qN included in the descriptor buffer 34. The transmit data request issued by the transmit data read unit 35 includes the address, data length (size), and the like of the transmit data to be read based on the transmit data request and is output to the host side memory 20 via the first interface unit 32.

The transmit data read from the transmit data area 20a based on the transmit data request output to the host side memory 20 as described above is input to the data transfer device 30 via the first interface The transmit data thus input to the data unit 32. transfer device 30 is output to the memory 40 via the second interface unit 36.

The second interface unit 36 is an interface for connecting the data transfer device 30 with the memory 40.

The memory 40 includes a queue Q, and the transmit data output from the data transfer device 30 (i.e., the second interface unit 36) as described above is stored in the queue Q.

Although omitted in FIG. 1, the memory 40 is used by the network device provided in the communication device 1, and the network device transmits the transmit data stored in the memory 40 (i.e., the queue Q) to the network (for example, a network based on Ethernet). Incidentally, the network device is a device for connecting to the network and includes, for example, a network interface card (NIC). In this case, the memory 40 can be referred to as, for example, a transmission memory for the NIC (NIC side memory).

In addition, the above-described descriptor area 20b is assumed to be realized as, for example, a ring buffer for each priority. The ring buffer is configured to store a plurality of data elements (i.e., descriptors), and the data in the ring buffer is managed using a write pointer (Head) indicative of a position where the data is written and a read pointer (Tail) indicative of a position where the data is read. Incidentally, the write pointer is updated each time the data is written to the ring buffer. In addition, the read pointer is updated each time the data is read from the ring buffer. When the descriptor area 20b is realized with the ring buffer, a head address of the ring buffer, a length of the ring buffer, a write pointer (Head), a read pointer (Tail), and the like are stored for each priority, in the above-described descriptor information in the host interface 31. The head address of the ring buffer, the length of the ring buffer, and the like are set at the time when the descriptor area 20b is secured, such as the time of initialization of the data transfer device 30. When transmitting the data, the driver 10a confirms whether a free space exists in the ring buffer based on the Head and the Tail of the priority. If a free space exists, the data transfer device 30 is notified that the transmit data exists, by advancing the Head after preparing the descriptors and the transmit data. When determining that the transmit data exists in the ring buffer based on the Head and the Tail, the data transfer device 30 executes the data transmission process. It is possible to notify the driver 10a that the data transmission is completed, by advancing the Tail when a series of processes are completed. Although omitted in the present embodiment, the data transmission device 30 comprises a mechanism of interrupt signals, and the like, and the CPU 10 is notified of the fact that Tail has been updated, by an interrupt.

Furthermore, it is assumed that the data transfer device 30 (DMAC) included in the communication device 1 shown in FIG. 1 is used when the transmit data is transferred between two memories (i.e., the host side memory 20 and the transmission memory 40 for NIC), but the data transfer device 30 may also be used when the transmit data is transferred between processing units (devices) other than the memories, such as NIC and a graphics processing unit (GPU).

In addition, it has been described that the data transfer device 30 includes the host interface 31, the first interface unit 32, the descriptor read unit 33, the descriptor buffer 34, the transmit data read unit 35, and the second interface unit 36 in FIG. 1, but at least some of the units in the data transfer device 30 may be realized by software or hardware or by a combination of software and hardware.

Furthermore, it has been described that the transmission memory 40 for NIC includes one queue Q in FIG. 1, but the transmission memory 40 for NIC may include a plurality of queues (for example, queues Q0 to QN) prepared for each priority specified for the above-described transmit data.

In addition, it has been described that the communication device 1 comprises the host side memory 20, the data transfer device 30, and the transmission memory 40 for NIC in FIG. 1, but some of the CPU 10, the host side memory 20, the data transfer device 30, and the transmission memory 40 for NIC may be configured integrally. Alternatively, for example, the data transfer device 30 may be incorporated into the NIC or the like as a data transfer unit (transfer processing unit).

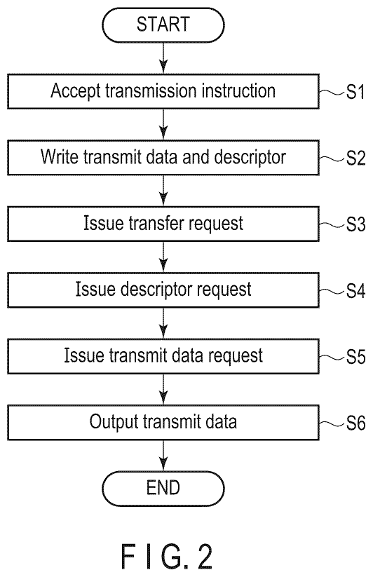

Next, an example of a procedure of the communication device 1 according to a comparative example of the present embodiment will be described with reference to a flowchart of FIG. 2. Incidentally, a predetermined priority is specified for the transmit data in the present embodiment, but the priority may simply be referred to as the priority of the transmit data in the following description. In addition, the priority of the transmit data may also be referred to as a priority of the descriptor in which information on the transmit data is described (hereinafter referred to as a descriptor of the transmit data), a priority of the transmission request requesting the transmit data, or a priority of the descriptor request requesting the descriptor.

First, when the transmit data is generated by the CPU 10 executing an application program, the driver 10a accepts a transmission instruction for the transmit data from the application program (step S1).

If the transmission instruction of the transmit data is accepted in step S1, the driver 10a writes the transmit data and the descriptor of the transmit data to the host side memory 20 (step S2).

In step S2, the transmit data is written to the queue corresponding to the priority of the transmit data among the queues q0 to qN included in the transmit data area 20a included in the host side memory 20. Similarly, the descriptor of the transmit data is written to the queue corresponding to the priority of the descriptor (i.e., the priority of the transmit data) among the queues q0 to qN included in the descriptor area 20b included in the host side memory 20.

Incidentally, if, for example, the queues q0 to qN included in the transmit data area 20a correspond to the queues q0 to qN included in the descriptor area 20b and if the priority of the transmit data corresponds to, for example, the queue N, the transmit data is written to the queue N included in the transmit data area 20a, and the descriptor of the transmit data is written to the queue N included in the descriptor area 20b.

If the descriptor is written to the queue N included in the descriptor area 20b, the write pointer that manages the data in the queue N (ring buffer) is updated to indicate a position where the descriptor is to be written next. The queue N included in the descriptor area 20b has been described, and the same process is executed if other queues are composed of ring buffers.

When the process of step S2 is executed, the driver 10a issues a transfer request (i.e., a request for transferring the transmit data) to the data transfer device 30 (step S3). Incidentally, the transfer request issued in step S3 includes descriptor information. This descriptor information includes a pointer indicative of the position in the descriptor area 20b where the descriptor is written in step S2 (i.e., a read pointer of the ring buffer), and the like, and is stored in the register area corresponding to the priority of the transmit data and the descriptor written to the host side memory 20 in step S2, among the queues q0 to qN register areas included in the host interface 31 included in the data transfer device 30.

When the descriptor information is stored in the register area included in the host interface 31 as described above, the write pointer that manages the data in the queue (ring buffer) is updated, and the descriptor read unit 33 detects the transfer request from the driver 10a based on such an update of the write pointer.

In this case, the descriptor read unit 33 issues the descriptor request based on the pointer included in the descriptor information stored in the queues q0 to qN register areas included in the host interface 31 (step S4). The descriptor request issued in step S4 is a request to read THE descriptor from the position indicated by the pointer included in the descriptor information and is output to the host side memory 20 via the first interface unit 32.

When the process of step S4 is executed, the descriptor is read from the descriptor area 20b based on the descriptor request, and the read descriptor is input to the data transfer device 30 via the first interface unit 32. The descriptor thus input to the data transfer device 30 via the first interface unit 32 is stored in the descriptor buffer 34. The descriptor buffer 34 includes the queues q0 to qN, and the descriptor input to the data transfer device 30 is stored in the queue corresponding to the priority of the descriptor among the queues q0 to qN.

Next, the transmit data read unit 35 issues a transmit data request based on the descriptor stored in the queues q0 to qN included in the descriptor buffer 34 (step S5). As described above, the descriptor includes the data length of the transmit data, the address of the transmit data area 20a to which the transmit data is written, and the like, and the transmit data request issued in step S5 is a request to read the transmit data of the data length from the address of the transmit data area 20a. The transmit data request is output to the host side memory 20 via the first interface unit 32.

When the process of step S5 is executed, the transmit data is read from the transmit data area 20a based on the transmit data request, and the read transmit data is input to the data transfer device 30 via the first interface unit 32.

The transmit data thus input to the data transfer device 30 via the first interface unit 32 is output to the transmission memory 40 for NIC via the second interface unit 36 (step S6).

In the comparative example of the embodiment, the transmit data can be transmitted from the host side memory 20 to the transmission memory 40 for NIC via the first interface unit 32 and the second interface unit 36, by executing the above-described processing shown in FIG. 2. The transmit data thus transferred from the host side memory 20 to the transmission memory 40 for NIC by the data transfer device 30 is transmitted to the network (i.e., an external device, or the like) via the NIC.

Incidentally, for example, a descriptor request is issued based on the pointer included in the descriptor information stored in the queues q0 to qN register areas included in the host interface 31, in the above-described processing shown in FIG. 2 and, when a delay occurs in the descriptor read process based on the descriptor request, the write pointer (Head) in the queues q0 to qN register areas included in the host interface 31 may advance during the occurrence of the delay, and descriptors with two or more priorities may be stored in the descriptor area 20b.

In this case, the descriptor read unit 33 operates to select one queue of two or more priorities in which the descriptor information is stored and issue the descriptor request based on the pointer included in the descriptor information stored in the register area of the selected priority. More specifically, the descriptor read unit 33 can select the queue (for example, queue qN) corresponding to the highest priority among two or more register areas in which the descriptor information is stored, for example, according to Strict Priority. Incidentally, the queue selection may be executed according to, for example, other algorithms such as Round-Robin method.

It has been described that the descriptor read unit 33 selects one queue included in the host interface 31 but, if the descriptors are stored in two or more of the queues q0 to qN included in the descriptor buffer 34, the transmit data read unit 35 selects one queue in the same manner as the descriptor read unit 33 to issue the transmit data request. In addition, the descriptor read unit 33 and the transmit data read unit 35 may issue requests simultaneously. In this case, one request is selected in the first interface unit 32. In this case, the descriptor request and the transmit data request may be prioritized and processed with Strict Priority (for example, the priority may be set such that the transmit data request always has high priority), or the descriptor request and the transmit data request may be issued alternately with Round-Robin. Incidentally, the descriptor request and the transmit data request may not be distinguished but the priority may be set for each of the requests and the request may be selected at the first interface unit 32.

Incidentally, it is assumed that the priorities of the above-described queues q0 to qN register areas included in the host interface 31 and the plurality of queues q0 to qN included in the descriptor buffer 34 are higher in the order of, for example, the queues q0, q1, . . . , qN, for example, but the priorities of the respective queues q0 to qN (i.e., the correspondence between each of the queues q0 to qN and the priority) may be managed in, for example, a mapping table or the like and may be changed as necessary.

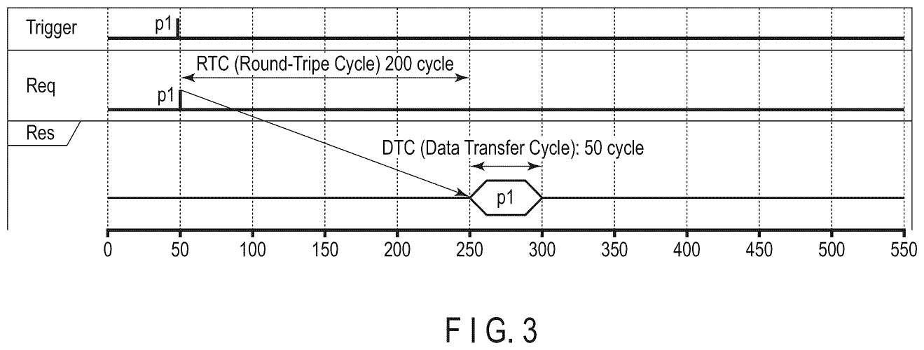

A processing time of the data transfer device 30 according to the comparative example of the embodiment will be described below with reference to FIG. 3. FIG. 3 shows relationships among trigger (Trigger), request (Req), and response (Res) in the data transfer device 30.

The trigger shown in FIG. 3 is indicative of the trigger for issuing a request. The Request is indicative of the request to transfer the data issued based on the trigger. The response is a response to the request, which is input to the data transfer device 30 (read from the host side memory 20) via the first interface unit 32 by issuing the request. In addition, a horizontal axis (numerical values from 0 to 550) in FIG. 3 is indicative of a clock cycle (clock period) in the data transfer device 30 (DMAC).

The requests issued in the data transfer device 30 according to the comparative example of the embodiment include descriptor requests and transmit data requests.

The request shown in FIG. 3 is not distinguished into a descriptor request and a transmit data request. However, when the request is a descriptor request, the fact that the descriptor information included in the transfer request is stored in the queue of one of the queues q0 to qN register areas in the host interface 31 is the trigger, and the descriptor input from the host side memory 20 based on the descriptor request is the response.

In contrast, if the request is a transmit data request, the fact that the trigger is stored in one queue among the queues q0 to qN included in the descriptor buffer 34 is the trigger, and the transmit data input from the host side memory 20 based on the transmit data request is the response.

Incidentally, FIG. 3 shows the operation of the data transfer device 30, which is related to the request to transfer the transmit data of priority p1. In the following descriptions, the request for transferring the transmit data of the priority p1 is referred to as request p1, the trigger that triggers the issuance of the request p1 is referred to as trigger p1, and the response to the request p1 is referred to as response p1.

First, as shown in FIG. 3, it is assumed that the trigger p1 occurs in, for example, the 49-th clock cycle. In this case, for example, the request p1 is issued in the 50-th clock cycle immediately after the trigger p1 occurs.

When the request p1 is issued in this manner, the request p1 is output to the host side memory 20 via the first interface unit 32, and the response p1 read by the host side memory 20 is input to the data transfer device 30 via the first interface unit 32.

The response p1 (descriptor or transmit data) input to the data transfer device 30 is immediately output to a memory of output destination (descriptor buffer 34 or transmission memory 40 for NIC).

Incidentally, in the comparative example of the present embodiment, a period of time required after the request p1 is issued and until the input of the response p1 to the data transfer device 30 is actually started (i.e., until the start part of the response p1 is input to the data transfer device 30), as described above, is defined as Round-Tripe Cycle (RTC). The RTC is represented by, for example, the number of clock cycles and is generated based on the processing delay in the path between the data transfer device 30 (DMAC) and the host side memory 20. This processing delay is caused by, for example, AXI4 Interconnect to connect to the host side memory 20, processing of the memory controller on the side of the bus and host such as PCIe, and the like. For this reason, the RTC is not constant and is varied depending on the connected IP cores, controllers, bus and memory load, and the like.

In the example shown in FIG. 3, since the request p1 is issued in the 50-th cycle and the input of the response p1 is started in the 250-th cycle, the RTC is 200 cycles.

In addition, in the comparative example of the present embodiment, a period of time required after the input of the response p1 via the first interface unit 32 is started and until the input is completed is defined as Data Transfer Cycle (DTC). Incidentally, when it is considered that the response p1 input to the data transfer device 30 is immediately output to the memory of the output destination, as described above, the DTC can also be defined as the period of time required to output (transfer) the response p1 input to the data transfer device 30 to the memory of the output destination. The DTC is expressed by, for example, the number of clock cycles, in the same manner as the above-described RTC.

Incidentally, when the data transfer device 30 (DMAC) can process data without delay and the memory of the output destination (FIFO memory or the like) includes a free space, the DTC can be calculated from the data length (number of transfer size) and bus width (minimum value among the bus width of the host side memory 20 and the bus width of the memory at the output destination) of the response p1 to the request p1 that the data transfer device 30 issues for the host side memory 20. In other words, the DTC corresponds to the minimum number of clock cycles to process a response to one request.

In one example, for example, if a transmit data request requesting 1580 bytes of transmit data is issued in an environment where the bus width is 32 bytes (256 bits), the DTC is 1580/32≈50 cycles. In this case, the DTC corresponds to the burst length required by burst accesses such as AXI4.

The processing clock cycle for one request (i.e., the period after a request is issued and until the input of the response is completed) is obtained by adding the RTC and DTC, and is 250 cycles in the example shown in FIG. 3. Incidentally, this processing clock cycle can be converted to processing time by using the operating clock frequency of the data transfer device 30 (DMAC). For example, if the data transfer device 30 (and bus) is assumed to operate at 125 MHz, one clock cycle is 8 ns, and the processing time is 8×250=2000 ns.

A priority is specified for the transmit data in the comparison example, a situation is assumed where multiple requests (descriptor requests or transmit data requests) are issued sequentially to transfer transmit data of different priorities.

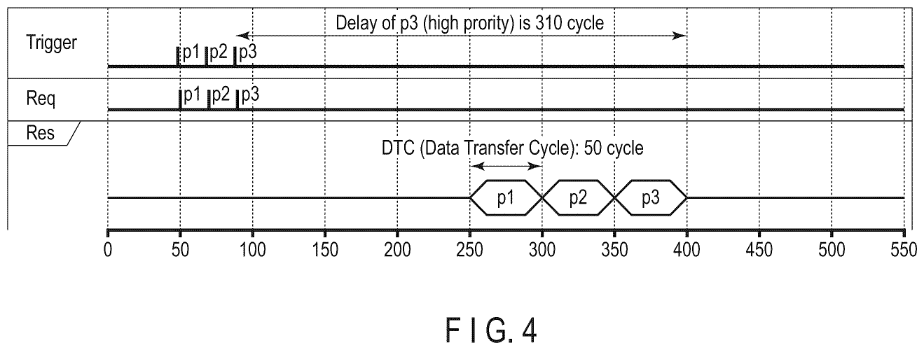

An example of a delay that occurs in a situation where a plurality of requests are issued sequentially to transfer transmit data of different priorities will be described below with reference to FIG. 4. In FIG. 4, detailed descriptions of the same portions as those in FIG. 3 will be omitted.

Incidentally, FIG. 4 shows the operation of the data transfer device 30, which is related to requests for transferring transmit data of priorities p1 to p3. In FIG. 3, the request, trigger, and response related to (the transmit data of) the priority p1 have been described as the request p1, the trigger p1, and the response p1, respectively. In FIG. 4, the request, trigger, and response related to (the transmit data of) the priorities p1 to p3 are referred to as requests p1 to p3, triggers p1 to p3, and responses p1 to p3, respectively. In addition, it is assumed that the priority p3 is higher than the priorities p1 and p2.

First, it is assumed that the triggers p1 to p3 sequentially occur as shown in FIG. 4. In this case, the data transfer device 30 issues the request p1 immediately after the trigger p1 occurs, issues the request p2 immediately after the trigger p2 occurs, and issues the request p3 immediately after the trigger p3 occurs, in accordance with the order of occurrence of the triggers p1 to p3. In this case, the request p1 is issued in the 50-th clock cycle, the request p2 is issued in the 70-th clock cycle, and the request p3 is issued in the 90-th clock cycle.

When the request p1 is issued, the input of the response p1 is started at the timing when the above-described RTC has elapsed, and the input of the response p1 is completed at the timing when the DTC has elapsed, in the data transfer device 30. More specifically, if the RTC is assumed to be 200 cycles and the DTC is assumed to be 50 cycles as described above, the input of the response p1 is started at the 250-th clock cycle and completed at the 300-th clock cycle.

Next, it is assumed that the request p2 is issued. If it is assumed that the request p1 is not issued, the input of the response p2 is considered to be started in the 270-th clock cycle. As shown in FIG. 4, however, if the request p1 is issued, the input of the response p1 is not completed at the timing of the 270-th clock cycle, and the input of the response p2 cannot be started in the 270-th clock cycle. For this reason, the input of the response p2 is started in the 300-th clock cycle when the input of the response p1 is completed, and is completed in the 350-th clock cycle.

Furthermore, it is assumed that the request p3 is issued. If it is assumed that the requests p1 and p2 are not issued, the input of response p3 is considered to be started in the 290-th clock cycle. As shown in FIG. 4, however, if the requests p1 and p2 are issued, the input of the responses p1 and p2 is not completed at the timing of the 290-th clock cycle, and the input of the response p3 cannot be started in the 290-th clock cycle. For this reason, the input of the response p3 is started in the 350-th clock cycle when the input of the responses p1 and p2 is completed, and is completed in the 400-th clock cycle. Therefore, it is shown in FIG. 4 that 310 clock cycles are required after the trigger p3 that triggers the request p3 described above occurs and until the input of the response p3 is completed.

In other words, according to the example shown in FIG. 4, it can be understood that although the input of the response p3 is completed in the 340-th clock cycle at the earliest when the request p3 is issued in the 90-th clock cycle, the low-priority requests p1 and p2 are already issued and delay to completion of the input of the response p3 to the high-priority request p3 becomes therefore great.

The above-described delay is caused by an influence of the data length (number of burst accesses) that can be input (requested) by one request and the bus bandwidth. For example, if the bus protocol is assumed to be AXI4 Memory Mapped Interface, the maximum data size that can be requested by one request is 4 KB when the bus width is 32 bytes.

Incidentally, the maximum burst length in AXI4 Memory Mapped Interface is 256. In this case, if the bus width is assumed to be 32 bytes, the data length (maximum request size) that can be requested by one request is 8192 bytes (32 bytes×256). However, since the burst access beyond the 4 KB address boundary cannot be made with AXI-4, the actual maximum value is 4096 bytes (i.e., 4 KB).

The number of clock cycles required to input 4 KB (data) based on the request is 128 (clock cycles), which is calculated by dividing 4 KB by 32 bytes, i.e., the bus width. For this reason, when a request is immediately issued each time a trigger occurs, the number of clock cycles required to input the response to the request accumulates, resulting in a delay in the response to a subsequent request (i.e., a request to transfer high-priority transmit data).

Therefore, a configuration to suppress a delay of response to request to transfer the high-priority data as described above in FIG. 4 will be described in the present embodiment.

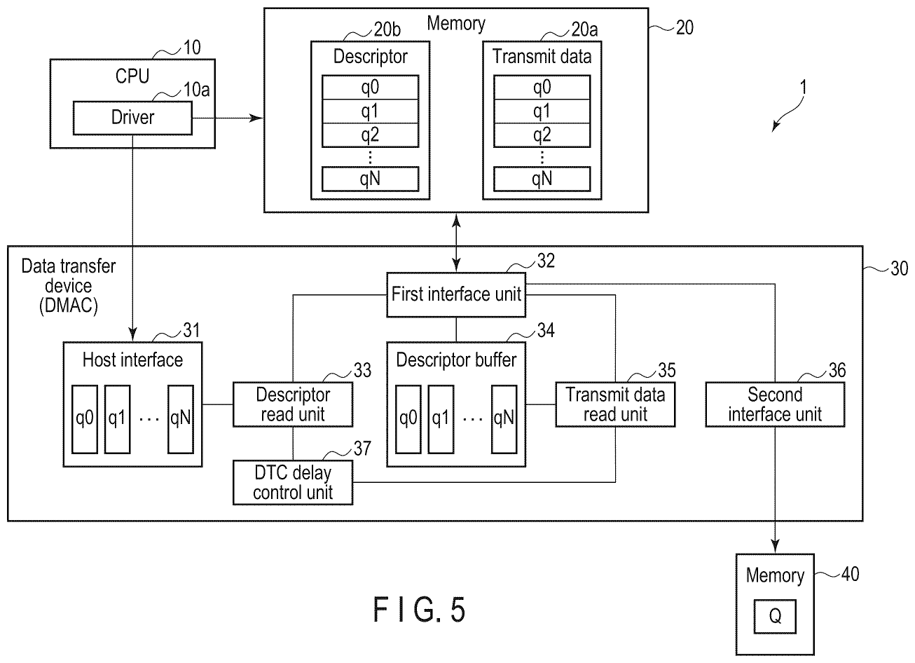

FIG. 5 shows an example of a configuration of a communication device in the present embodiment. In FIG. 5, the same portions as those in FIG. 1 will be denoted by the same reference numerals and their detailed descriptions will be omitted, and portions different from FIG. 1 will be mainly described.

As shown in FIG. 5, the data transfer device 30 includes a DTC delay control unit (controller) 37, in the communication device 1 in the present embodiment.

The DTC delay control unit 37 holds a counter inside the unit. When issuing the request (i.e., the descriptor request or the transmit data request), the DTC delay control unit 37 sets in the counter the DTC required by the request (i.e., the number of clock cycles required after the input of the response to the request is started and until the input is completed). The DTC delay control unit 37 stops issuing a next request until the number of clock cycles set in the counter in this manner has elapsed.

Incidentally, the suspension of issuing a request is realized by the DTC delay control unit 37 instructing the descriptor read unit 33 or the transmit data read unit 35 that issues the request.

In addition, in the present embodiment, the DTC is assumed to be set in the counter held inside the DTC delay control unit 37. However, a value obtained by adding or subtracting a constant to or from the DTC (i.e., the result of predetermined calculation on the DTC) may be set in the counter.

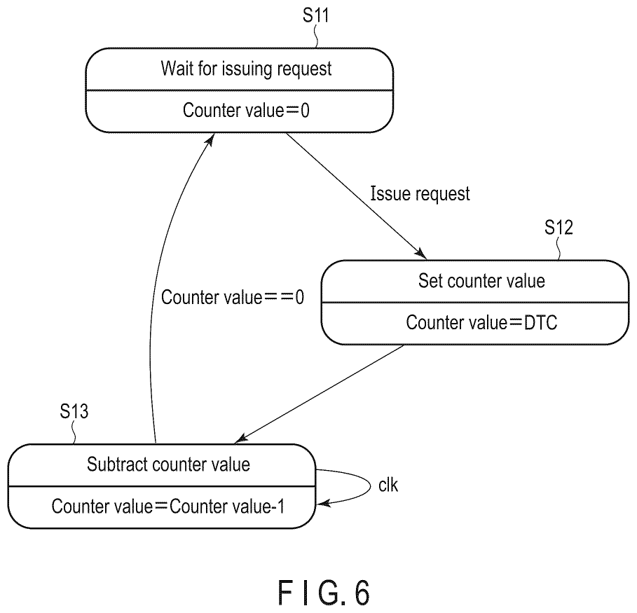

Next, an example of the operation of the above-described DTC delay control unit 37 will be described with reference to FIG. 6. Incidentally, the DTC delay control unit 37 operates, for example, at the timing when processes in step S4 or S5 shown in FIG. 2 are executed.

First, if the above-described trigger does not occur, the DTC delay control unit 37 is in a state of waiting for issuing a request (step S11).

It is assumed that a trigger occurs and a request is issued based on the trigger. In this case, the DTC delay control unit 37 sets the DTC required for the issued request, in the counter held inside the DTC delay control unit 37 (step S12). Incidentally, the DTC set in the counter is calculated from the data length and bus width of the response to the request.

Next, the DTC delay control unit 37 subtracts the counter value for which the DTC is set in step S12 in every clock cycle (step S13). The process in step S13 is repeated until the counter value reaches 0, and the counter value becomes 0 at the timing when the DTC (number of clock cycles) has elapsed. In other words, the DTC delay control unit 37 operates to decrease the counter value according to the clock cycles.

If the counter value set in the counter is not 0 (i.e., indicates a value other than zero), the DTC delay control unit 37 stops (prohibits) issuing the next request to the host side memory 20 and repeats the process in step S13.

In contrast, if the counter value set in the counter is 0 (i.e., the counter value has been decremented to 0), the DTC delay control unit 37 cancels the suspension (prohibition) of issuing the next request to the host side memory 20 and returns to step S11 to repeat the process.

Incidentally, if a plurality of triggers occur when the process is repeated back to step S11, a high-priority request is selected among the plurality of requests that can be issued based on each of the plurality of triggers, and the selected request is issued.

According to this operation of the DTC delay control unit 37, the next request can be issued after the DTC (number of clock cycles) required for the request has elapsed, each time the request is issued.

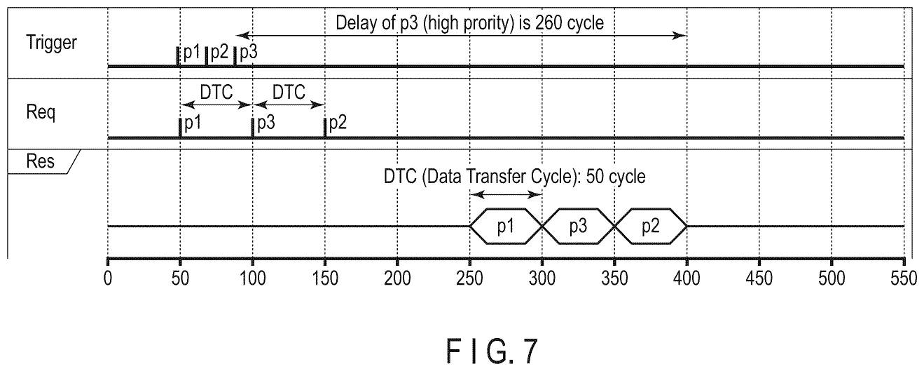

As described above, when issuing the request p1 (first request) to transfer the transmit data (first data) of the priority p via the first interface unit 32, the data transfer device 30 of the present embodiment stops issuing the request p2 (second request) to transfer the transmit data (second data) of the priority p2 while a period of time required after the input of the response p1 to the request p1 via the first interface unit 32 is started and until the input is completed (i.e., the DTC required for the request p1) has elapsed, as shown in, for example, FIG. 7.

According to this, for example, if issuing the request p3 (i.e., the third request to transfer the third data) can be executed by the trigger p3 occurring while issuing the request p2 is stopped, the high-priority request p3 can be issued with priority to the low-priority request p2.

More specifically, unlike FIG. 4 (comparative example of the present embodiment), the data transfer device 30 of the present embodiment does not issue the requests p2 and p3 immediately after the triggers p2 and p3 occur as shown in FIG. 7, by setting the DTC (for example, 50 cycles) required for the request p1 in the counter at the timing when the request p1 is issued. In the example shown in FIG. 7, issuing the request subsequent to the request p1 is stopped until the 100-th clock cycle.

In addition, in the example shown in FIG. 7, the requests p2 and p3 can be issued at the timing of the 100-th clock cycle when the counter value becomes 0 (i.e., the suspension of issuing the request is canceled). In this case, the request p3 with a high priority is issued according to, for example, Strict Priority.

According to this, the number of clock cycles required after the trigger p3 occurs and until the input of the response p3 is completed is 260 cycles, and it can be understood that the processing time of the data transfer device 30 is shorter by 50 clock cycles than 310 clock cycles described above with reference to FIG. 4 (i.e., the delay is small).

Incidentally, as shown in FIG. 7, the timing at which all the inputs of the responses p1 to p3 are completed is the 400-th clock cycle, which is the same as the above-described timing in FIG. 4 (comparative example of the present embodiment). In other words, in the present embodiment, even if issuing the requests is temporarily stopped as described above, the processing of the entire data transfer device 30 is not delayed.

In the present embodiment, with the above-described configuration, it is possible to suppress giving an influence of issuing the low-priority requests to the input (transfer) of the response to the high-priority requests, and to implement the low delay (i.e., high real-time performance) in communications such as transmitting the transmit data generated in the host device (application program) over the network, by considering the DTC (burst length of request).

Incidentally, in the present embodiment, it is assumed that issuing both the descriptor request and the transmit data request is stopped, but the request whose issuance is stopped may be either a descriptor request or a transmit data request. In other words, in the present embodiment, for example, when the transmit data request is issued, issuing the next transmit data request may be stopped until the DTC required for the transmit data request (i.e., the number of clock cycles required to input the transmit data) elapses, while the descriptor request may be issued immediately at the timing at which the trigger occurs. Similarly in the present embodiment, for example, when the descriptor request is issued, issuing the next descriptor request may be stopped until the DTC required for the descriptor request (i.e., the number of clock cycles required to input the descriptor) elapses, while the transmit data request may be issued immediately at the timing at which the trigger occurs. Even in such a configuration, the delay related to the input (read) of at least one of the descriptor and the transmit data can be improved, which, as a result, contributes to achieving low delay in communication.

In addition, when issuing both the descriptor requests and transmit data requests is stopped as described above, if the memories in which the descriptors and the transmit data are held are separated or if the interfaces accessing the memories are different, the counter values may be managed individually for each of the descriptor requests and the transmit data requests.

Incidentally, according to the data transfer device 30 of the present embodiment, issuing the requests is stopped regardless of the priority, but the requests whose issuance is stopped may be determined (selected) based on such priority. More specifically, it has been described that, in the present embodiment, issuing the requests of all priorities is stopped when the counter value is a value other than zero. For example, however, the present embodiment may stop issuing an only request whose priority is less than a threshold value (i.e., a request with a priority lower than a predetermined priority) and may not stop issuing a request whose priority is higher than or equal to a threshold value (i.e., immediately issue the request even if the counter value is a value other than 0).

By the way, in the present embodiment, it is assumed that, for example, the transmit data is transmitted to an Ethernet-based network via a NIC as described above. For example, standardization of Time-Sensitive Network (TSN), which implements high real-time performance over Ethernet, is promoted by the IEEE 802.1 TSN Task. TSN is a standard which is composed of a plurality of standards and extended by considering application of Audio/Video Bridging (AVB), which implements low-delay performance used in pro-audio and other applications to industrial networks and automotive networks. TSN aims to achieve higher reliability in addition to higher real-time performance than AVB.

One of the TSN standards is IEEE 802.1Qbv. IEEE 802.1Qbv can strictly control frame (data) transmission timing for each traffic class (priority), by controlling a plurality of queues (transmission queues) with different priorities based on gate control information (schedule information) set in advance. A gate which permits the frame transmission is set in each queue. The frame transmission is permitted when the gate is open, and the frame transmission is prohibited when the gate is closed. A state (open or closed) of each gate for one cycle is set in the gate control information.

NIC or the like corresponding to IEEE 802.1Qbv executes the frame transmission process by selecting a priority queue that can transmit frames from the current time, gate control information, a gate control start time, and the like. In other words, in IEEE 802.1Qbv, the transmission timing of frames is controlled for each traffic class corresponding to the priority.

By strictly controlling the frame transmission timing according to such gate control information, it is possible to prevent transmission timing from colliding between frames with different priorities and to reduce the transmission delay time and fluctuations of such transmission delay time.

In addition, IEEE 802.1Qbu/802.3br, which is another TSN standard, stops the processing of frames being transmitted and interrupts the transmission processing of high-priority frames when the transmission processing of high-priority frames occurs.

By using real-time Ethernet such as TSN as described above, it is possible to reduce a network delay related to the transmission of data that requires high real-time performance.

Incidentally, the scope of the real-time Ethernet standards such as TSN is the network processing between the NIC and the network. However, when a communication system is actually constructed, the processing between the host device and the NIC also needs to be considered. More specifically, since the process of transferring the transmit data (frames) input from the host side memory 20 to the transmission memory 40 for NIC by the DMA processing as described in the present embodiment is executed asynchronously with the timing of the transmission control of the TSN, the DMA processing of low-priority transmit data may affect the DMA processing of the high-priority transmit data when access to the memory or bus is congested.

Therefore, an influence of the process of transferring the low-priority transmit data, which is given to the process of transferring the high-priority transmit data, is suppressed, and the transfer delay is reduced, by controlling the timing of issuing the requests to transfer the transmit data of different priorities from the host side memory 20 to the transmission memory 40 (transmission queue) for NIC.

Incidentally, when applying the TSN to the communication device 1 in the present embodiment as described above is considered, the transmission memory 40 for NIC has, for example, queues Q0 to QN (queues of transmission destinations) corresponding to the priorities (traffic classes). The data transfer device 30 of the present embodiment may be configured to set the attributes for each of the queues Q0 to QN and control (determine) whether or not to stop issuing the requests for each of the attributes.

For example, in IEEE 802.1Qbu/803.3br, the Media Access Controller (MAC) to which the queue is connected is classified into attributes referred to as Preemptable and Express. In this case, suspension of issuing the only requests for transferring the transmit data stored in the queues connected to Preemptable, which do not need to be transmitted with relatively low delay is considered.

To realize such a configuration, the attributes (Preemptable or Express) of each of the queues Q0 to QN in the transmission memory 40 for NIC as described above need to be discriminated, and the data transfer device 30 (DMAC) is assumed to include a table for discriminating the attributes of each of the queues Q0 to QN (hereinafter referred to as an attribute discrimination table). For example, this attribute discrimination table (i.e., the correspondence between the queues Q0 to QN and their attributes) may be set from the CPU 10 or the like via the host interface 31.

The attributes of each of the queues Q0 to QN described here may have different viewpoints from the priority of the transmit data described in the present embodiment (i.e., the attributes can be set independently of the priority).

Incidentally, in the present embodiment, it has been described that the RTC, DTC, and the like are expressed in the number of clock cycles, but the RTC, DTC, and the like may be expressed in the time in consideration of the fact that the clock cycle can be converted into the time using the operating clock frequency of the data transfer device 30 as described above. In this case, the DTC (counter value) set in the counter held inside the DTC delay control unit 37 as described above may be decreased as the time elapses (for example, if the counter is 1 ns granular, the counter value is decreased at every elapse of Ins in the counter of 1 ns particle size).

### Second Embodiment

Next, a second embodiment will be described. In the present embodiment, detailed descriptions of the same portions as those of the above-described first embodiment will be omitted and portions different from those of the first embodiment will be mainly described.

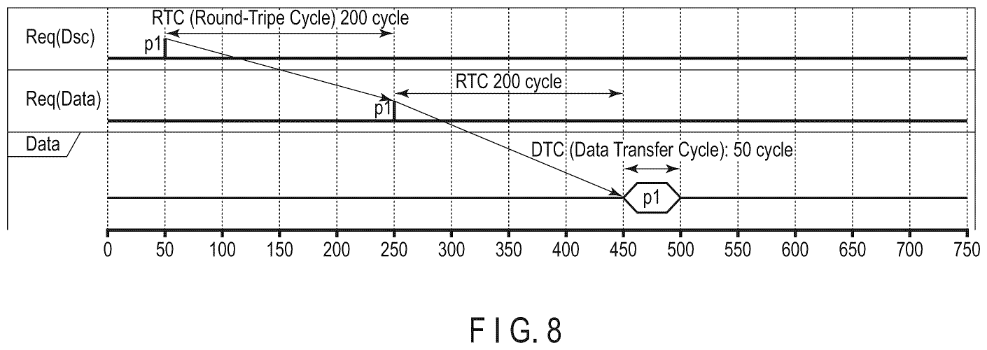

First, the data transfer device 30 of the above-described first embodiment will be considered as a comparative example of the present embodiment, and the processing time of the data transfer device 30 will be described with reference to FIG. 8. Incidentally, in FIG. 8, detailed descriptions of the same portions as those in FIG. 3 will be omitted.

FIG. 8 shows relationships between a descriptor request (Req(Dsc)), a transmit data request (Req(Data)), and a transmit data (Data) in the data transfer device 30.

Incidentally, FIG. 8 shows a series of operations of the data transfer device 30 when transferring transmit data of priority p1. In the following descriptions, a descriptor in which information on the transmit data of priority p1 is described is referred to as a descriptor p1, a descriptor request which requests the descriptor p1 is referred to as a descriptor request p1, a transmit data request which requests the transmit data of the priority p1 is referred to as a transmit data request p1, and the transmit data of the priority p1 is referred to as transmit data p1.

In addition, in FIG. 8, the descriptor request (Req(Dsc)) and the transmit data request (Req(Data)) issued by the data transfer device 30 and the transmit data (Data) input to the data transfer device 30 are shown, but descriptors (Dsc) input to the data transfer device 30 are omitted. Incidentally, in the following descriptions, a descriptor input to the data transfer device 30 based on the descriptor request p1 is also referred to as a descriptor p1 similarly to the transmit data p1 or the like.

As shown in FIG. 8, for example, when the descriptor request p1 is issued at the 50-th clock cycle, the descriptor request p1 is output to the host side memory 20 via the first interface unit 32, and the descriptor p1 read by the host side memory 20 (descriptor area 20b) is input to the data transfer device 30 via the first interface unit 32. Incidentally, a period of time (RTC) required after the descriptor request p1 is issued and until input of the descriptor p1 is actually started is 200 cycles.

It is assumed that the time required to input the descriptor p1 and write the descriptor to the descriptor buffer 34 is sufficiently small and that the transmit data request p1 is issued in the 250-th clock cycle. This is because in many cases, the descriptor size is small and the DTC required for a single descriptor transfer is one to several cycles. Incidentally, the descriptor p1 (size, address and the like of the transmit data p1) is used to issue the transmit data request p1 as the information necessary to transfer the transmit data p1 (frame).

When the transmit data request p1 is issued in this manner, the transmit data request p1 is output to the host side memory 20 via the first interface unit 32, and the transmit data p1 read by the host side memory 20 (transmit data area 20a) is input to the data transfer device 30 via the first interface unit 32. In the example shown in FIG. 8, the period of time (RTC) required after the transmit data request p1 is issued and until input of the transmit data p1 is actually started is 200 cycles.

Next, the input of the transmit data p1 is started at the timing (450-th clock cycle) when the RTC has elapsed after the transmit data request p1 is issued. In the example shown in FIG. 8, since the DTC is 50 cycles, the input of the transmit data p1 is completed in the 500-th clock cycle.

As described with reference to FIG. 8, memory read of the descriptor and the transmit data occurs at two times to transfer the transmit data (frame). For this reason, the transmit data transfer time (for example, the period elapsed after the descriptor request is issued and until the input of the transmit data is completed) is RTC*2+DTC. Incidentally, in the example shown in FIG. 8, the transmit data transfer time is 450 cycles. Incidentally, since several clock cycles are actually required for inputting the descriptors and writing to the descriptor buffer, this amount is added to the transfer time.

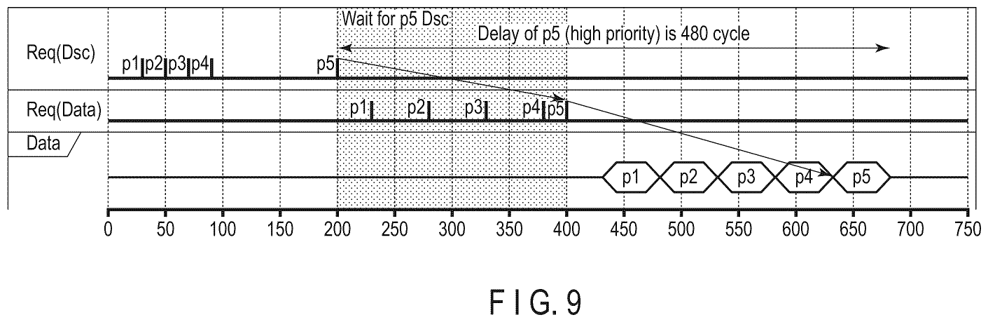

Next, an example of a delay which occurs in a situation where transmit data of different priorities are sequentially transferred will be described with reference to FIG. 9. In FIG. 9, detailed descriptions of the same portions as those in FIG. 8 will be omitted.

Incidentally, FIG. 9 shows a series of operations of the data transfer device 30 when transferring transmit data of priorities p1 to p5. In FIG. 8, the descriptor request, descriptor, transmit data request, and transmit data related to the priority p1 have been described as the descriptor request p1, the descriptor p1, the transmit data request p1, and the transmit data p1, respectively. In FIG. 9, the descriptor requests, descriptors, transmit data requests, and transmit data are referred to as descriptor requests p1 to p5, descriptors p1 to p5, transmit data requests p1 to p5, and transmit data p1 to p5, respectively. In addition, it is assumed that the priority p5 is higher than the priorities p1 to p4.

First, it is assumed that the descriptor requests p1 to p4 are sequentially issued as shown in FIG. 9. In this case, the descriptor request p1 is issued in the 30-th clock cycle, the descriptor request p2 is issued in the 50-th clock cycle, the descriptor request p3 is issued in the 70-th clock cycle, and the descriptor request p4 is issued in the 90-th clock cycle.

When the descriptor request p1 is issued, the input of the descriptor p1 is started after the above-described RTC has elapsed, and the transmit data request p1 is issued at the timing when the input of the descriptor p1 is completed, in the data transfer device 30. In the example shown in FIG. 9, the transmit data request p1 is issued in the 230-th clock cycle.

In contrast, when the descriptor request p2 is issued, the input of the descriptor p2 is started after the above-described RTC has elapsed, and the input of the descriptor p2 is completed, in the data transfer device 30. In the comparative example of the present embodiment, as described in the first embodiment, a transmit data request p2 is transmitted after the DTC elapses since the transmit data request p1 is issued (i.e., when the counter value is 0). In the example shown in FIG. 9, the transmit data request p2 is issued in the 280-th clock cycle.

The descriptor request p2 (transmit data request p2) has been described, and the descriptor requests p3 and p4 (transmit data requests p3 and p4) are also used in the same manner. Although detailed description is omitted, a transmit data request p3 is issued in the 330-th clock cycle, and the transmit data request p4 is issued in the 380-th clock cycle, in the example shown in FIG. 9.

It is assumed that the high-priority descriptor request p5 is issued in the 200-th clock cycle. When the descriptor request p5 is issued in this manner, the input of the descriptor p5 is started after the RTC has elapsed, and the transmit data request p5 is issued when the input of the descriptor p5 is completed, in the data transfer device 30. Incidentally, in FIG. 9, it is assumed that the input of descriptor p5 is completed after the above-described RTC has elapsed and that the transmit data request p5 is issued in the 400-th clock cycle.

However, the other transmit data requests p1 to p4 are already issued at the timing when the transmit data request p5 is issued and, as shown in FIG. 9, the input of the transmit data p5 based on the transmit data request p5 is started after the input (transfer) of the transmit data p1 to p4 is entirely completed.

More specifically, according to the example shown in FIG. 9, although the input of the transmit data p5 is completed in the 650-th clock cycle at the earliest when the descriptor request p5 is issued in the 200-th clock cycle, the input of the transmit data p5 is completed in the 680-th cycle (i.e., 480 clock cycles are required after the descriptor request p5 is issued and until the input of the transmit data p5 is completed). In other words, in the comparative example of the present embodiment, the delay until the input of the high-priority transmit data p5 is completed is larger due to the transfer process of the low-priority transmit data p1 to p4.

The above-described delay is caused by the fact that the transmit data request is issued immediately after the input (read) of each descriptor is completed. More specifically, the above-described input of the transmit data p5 is started in the 600-th clock cycle at the earliest (i.e., the timing at which the RTC has elapsed since the transmit data request p5 is issued in the 400-th clock cycle). If the data requests p1 to p4 are issued in a period between issuing the descriptor request p5 and issuing the transmit data request p5, it is confirmed that the input (transfer) of the transmit data p1 to p4 is not completed by the 600-th clock cycle. Thus, the transfer of the high-priority transmit data p5 is delayed due to an influence of the transfer of the low-priority transmit data p1 to p4.

Therefore, a configuration to suppress a delay in transfer of the high-priority transmit data as described above in FIG. 9 will be described in the present embodiment.

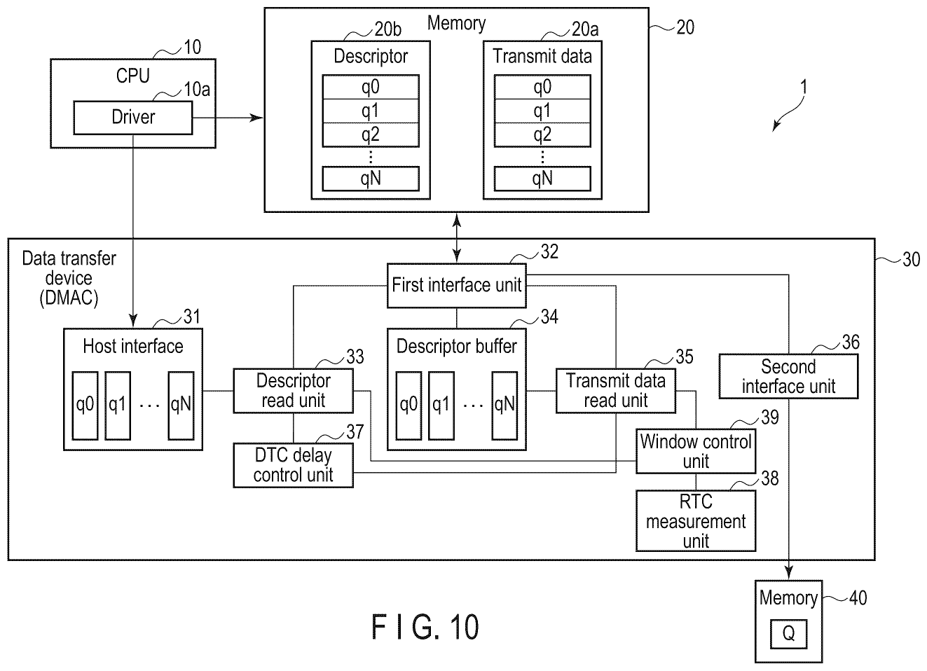

FIG. 10 shows an example of a configuration of the communication device in the present embodiment. In FIG. 10, the same portions as those in FIG. 5 will be denoted by the same reference numerals and their detailed descriptions will be omitted, and portions different from FIG. 5 will be mainly described.

As shown in FIG. 10, in the communication device 1 of the present embodiment, the data transfer device 30 includes an RTC measurement unit 38 and a window control unit (controller) 39.

The RTC measurement unit 38 monitors requests (descriptor requests and transmit data requests) to the host side memory 20 and measures the RTC (i.e., the period of time required after the requests are issued and until the input of the descriptors and the transmit data to the data transfer device 30 is actually started). The RTC measurement unit 38 holds (information on) the measured RTC inside the unit. Incidentally, the RTC held inside the RTC measurement unit 38 is a minimum value, a maximum value, an average value or the like of the RTC measured each time the request is issued as described above.

The window control unit 39 holds, for example, a counter value (hereinafter referred to as a window value) of each channel corresponding to the priority of the transmit data. Incidentally, the window value held in the window control unit 39 is set (determined) based on the above-described RTC held inside the RTC measurement unit 38 (i.e., the measurement result of the RTC measurement unit 38). The window control unit 39 determines whether or not to issue the low-priority transmit data request after the high-priority descriptor request is issued, based on the DTC which is required in the low-priority transmit data request (i.e., the data length of the transmit data to be input based on the transmit data request) and the window value held in the window control unit 39.

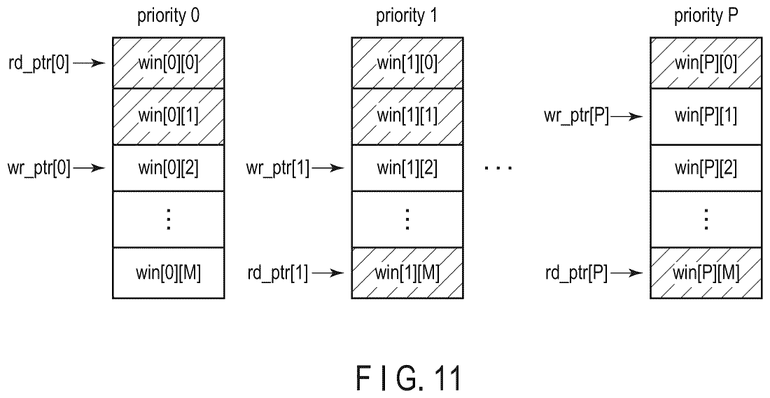

An outline of the window value held in the window control unit 39 will be described with reference to FIG. 11.

If priorities 0 to P are assumed to be specified for the transmit data in the present embodiment, the window control unit 39 holds M+1 window values 0 to M for each of (channels corresponding to) the priorities 0 to P. In the present embodiment, for example, the priority 0 is the lowest priority, and the priority P is the highest priority. Incidentally, the window values 0 to M held for each of the priorities 0 to P are stored in, for example, the ring buffer corresponding to the priority, and are managed using write pointers (wr_ptr) and read pointers (rd_ptr).

The write pointer is a pointer to indicate an area where the window value is set when the descriptor request is issued. The write pointer is updated so as to advance by one step at the timing at which the window value is set (i.e., to indicate an area where the window value is next set).

The read pointer is a pointer to indicate an area where the window value read (referenced) to control issuing and stopping the transmit data request is set. The above-described window value is set when the high-priority descriptor request is issued as described below. The read pointer is updated to advance by one step at the timing at which the transmit data request is issued based on the descriptor input based on the descriptor request issued when the window value is set (i.e., to indicate the area where the next window value is set).

Incidentally, according to the write pointers (wr_ptr) and the read pointers (rd_ptr) shown in FIG. 11, valid window values (i.e., window values that are not referenced after being set) are hatched.

In addition, in FIG. 11, the m-th (m=0 to M) window value among M+1 window values 0 to M of priority p (p=0 to P) is referred to as win[p][m], and wr_ptr and rd_ptr, which manage M+1 window values 0 to M of the priority p, are referred to as wr_ptr[p] and rd_ptr[p], respectively. The descriptions regarding the window values also apply below.

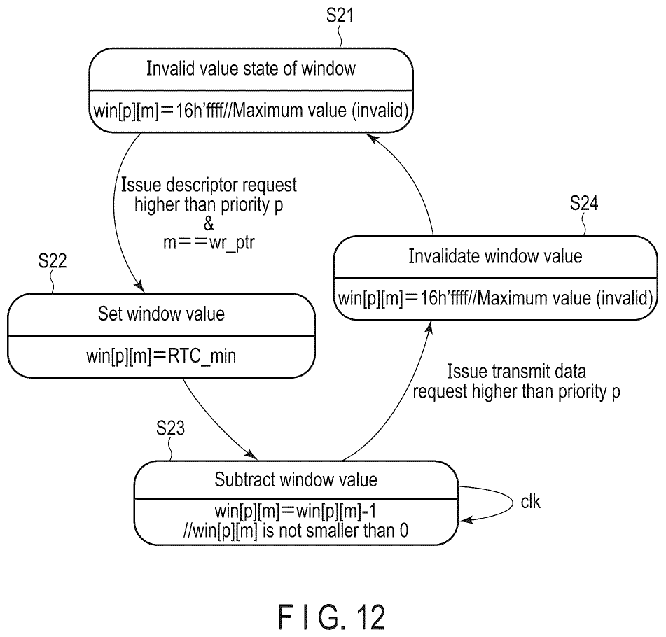

An example of the operation of the window control unit 39 will be described with reference to FIG. 12. Incidentally, the window control unit 39 operates, for example, at the timing when the above-described processes in step S4 and S5 shown in FIG. 2 are executed. In addition, the operation of the window control unit 39 regarding updating the m-th window value (win[p][m]) of the priority p will be mainly described.

First, the window control unit 39 sets the maximum value of the window value as win[p][m] at the time of startup (initialization) of the data transfer device 30 (DMAC) (step S21). Incidentally, the maximum value of the window value is 16h′ffff in 16-bit, but is not limited to 16-bit. The win[p][m] at which the maximum value of the window value is set in this manner corresponds to an invalid window value.

Next, when a descriptor request with a higher priority than the priority p is issued and the write pointer (wr_ptr) of the ring buffer of the priority p is indicative of the area where win[p][m] is set, the window control unit 39 sets the RTC held inside the RTC measurement unit 38 as the win[p][m] (step S22). The win[p][m] set in step S22 corresponds to a valid window value.

Incidentally, the RTC set in step S22 is, for example, the minimum value (RTC_min) of the RTC measured each time the request is issued, but may be a value obtained by adding or subtracting a constant to or from the minimum value of the RTC. Furthermore, the RTC set in step S22 may be, for example, the X-th RTC from the minimum value of the RTC measured each time the request is issued or may be an average value of such RTC. In addition, the RTC set in step S22 may be, for example, a value obtained by executing a predetermined calculation on the RTC measured each time the request is issued.

The window control unit 39 subtracts the win[p][m] (valid window value) for which the RTC is set in step S22 in every clock cycle (step S23). Incidentally, the process of step S23 is repeated until win[p][m] becomes 0, and the win[p][m] becomes 0 when RTC_min (number of clock cycles) or the like set in step S23 has elapsed. In other words, the window control unit 39 operates to decrease win[p][m] (i.e., the window value) according to the clock cycles. Incidentally, win[p][m] cannot not be less than 0.

As described above, win[p][m], which is subtracted at each clock cycle in step S23, is used as the DTC for requestable transmit data. For this reason, although omitted in FIG. 12, for example, if the read pointer (rd_ptr[p]) of the ring buffer corresponding to the priority p is indicative of the area where win[p][m] is held, the transmit data request of the priority p is issued only when the win[p][m] is larger than the DTC required for the transmit data request.

While the process of step S23 is repeatedly executed as described above (i.e., until win[p][m] becomes 0), when the transmit data request (i.e., a transmit data request with a higher priority than priority p) is issued based on the descriptor input based on the descriptor request with a higher priority than the priority p issued when the win[p][m] is set in step S22 described above, the window control unit 39 resets the win[p][m]. In this case, the window control unit 39 sets the maximum value (for example, 16h′ffff) of the window value as win[p][m] and invalidates win[p][m] (step S24).

When the above process of step S24 is executed, the process returns to step S21 and is repeated.

Incidentally, when win[p][m] is invalidated due to issuing the transmit data request with a priority higher than the priority p as described above, the read pointer (rd_ptr[p]) of the ring buffer corresponding to the priority p advances by one step, and the read destination (reference destination) of the window value in the ring buffer is thereby updated.

Incidentally, for example, the data transfer device 30 may operate to request (read) a plurality of descriptors by a single descriptor request. In this case, the number of descriptors requested in one descriptor request is held, and step $24 is executed at the timing when the transmit data request is issued based on all of the descriptors, and the read pointer is made to advance by one step.

In FIG. 12, updating win[p][m] has been mainly described, but the other window values are also updated in the same manner in the present embodiment. In other words, the window control unit 39 operates to update each of the (P+1)×(M+1) window values in parallel.

In addition, when all of the window values 0 to M held for each of the priorities 0 to P in the window control unit 39 are invalidated (i.e., when all the window values are set to the maximum values), issuing the transmit data requests using the window values is not limited.

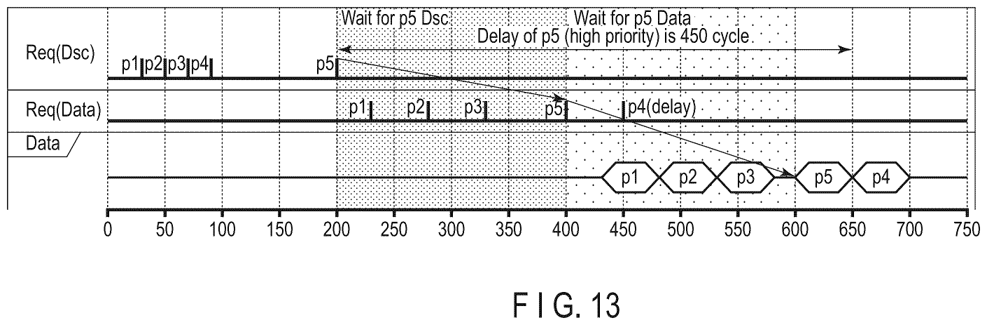

As described above, as shown in FIG. 13, for example, the data transfer device 30 of the present embodiment issues the descriptor requests p1 to p4 requesting the descriptors p1 to p4 (first descriptors) in which the information on the transmit data p1 to p4 (first data) is described, and issues the transmit data requests p1 to p4 (first data requests), based on the descriptors p1 to p4 input by issuing the descriptor requests p1 to p4.

In addition, the data transfer device 30 of the present embodiment sets the window value at the timing when the descriptor request p5 (i.e., the second descriptor request requesting the second descriptor in which the information on the second data is described) is issued after the descriptor requests p1 to p4 are issued, and decreases the window value according to the elapse of the clock cycle.

Furthermore, when the priorities of the transmit data p1 to p4 are lower than the priority of the transmit data p5 as described above, the data transfer device 30 of the present embodiment issues each of the transmit data requests p1 to p4, based on the period after the input of each of the transmit data p1 to p4 is started and until the input is completed (i.e., the DTC required for each of the data requests p1 to p4) and the window value.

More specifically, in FIG. 13, if the priority of the transmit data p5 is 2 and the priorities of the transmit data p1 to p4 are 0 or 1, the RTC held inside the RTC measurement unit 38 is set to the window values (win[0][(wr_ptr[0])] and win[1][(wr_ptr[1])]) set in the area indicated by the write pointer of the ring buffer corresponding to the priorities 0 and 1 when issuing the descriptor request p5.

When the RTC is set to win[0] [(wr_ptr[0])] and win[1] [(wr_ptr[1])] in this manner, the write destination of the window value in the ring buffer is updated by making each of the wr_ptr[0] and wr_ptr[1] (i.e., the write pointer of the ring buffer corresponding to the priorities 0 and 1) by one step.

Incidentally, although not shown in FIG. 13, for example, a descriptor request with the same priority as the transmit data p5 (or the priority higher than the descriptor request p5) may be issued sequentially with the transmit data p5. In the present embodiment, the window value is set each time such a descriptor request is issued. For this reason, the present embodiment adopts a configuration in which M+1 window values can be set for each of the priorities 0 to P.

It is assumed that RTC=200 cycles is set for win[0] [(wr_ptr[0])] and win[1] [(wr_ptr[1])] described above. The win[0] [(wr_ptr[0])] and win[1] [(wr_ptr[1])] for which 200 cycles are set in this manner are subtracted in accordance with elapse of the clock cycles.

In addition, it is assumed that the window value for which RTC=200 cycles is set as described above is indicated by the read pointer (rd_ptr[0], rd_ptr[1]). In this case, in the example shown in FIG. 13, the window values (win[0] [(rd_ptr[0])] and win[1] [(rd_ptr[1])]) in the 230-th clock cycle in which the transmit data request p1 is transmitted are 200−30=170, and the DTC required for the transmit data request p1 is 50. In this case, since the window value is larger than the DTC required for the transmit data request p1, issuing the transmit data request p1 is not stopped (i.e., the transmit data request p1 is issued).

The transmit data request p1 has been described, but the window value in the 280-th clock cycle when the transmit data request p2 is transmitted is 170−50=120, and the DTC required for the transmit data request p2 is 50. In this case, since the window value is larger than the DTC required for the transmit data request p2, issuing the transmit data request p2 is not stopped.

Similarly, the window value in the 330-th clock cycle when the transmit data request p3 is transmitted is 120−50=80, and the DTC required for the transmit data request p3 is 50. In this case, since the window value is larger than the DTC required for the transmit data request p3, issuing the transmit data request p3 is not stopped.

In contrast, the window value in the 380-th clock cycle when the transmit data request p4 is transmitted is 80−50=30, and the DTC required for the transmit data request p4 is 50. In this case, since the window value is smaller than the DTC required for the transmit data request p4, issuing the transmit data request p4 is stopped.

According to this, when a transmit data request p5 is issued without delay in the 400-th clock cycle when the transmit data request p5 can be issued, the input of the transmit data request p5 can be completed in the 650-th clock cycle, and a low delay in the transfer of the high-priority transmit data p5 can be therefore implemented as compared to the case described in FIG. 9.

In the present embodiment, when the window value is managed as described above and the low-priority transmit data request occurs, a delay in transfer of the high-purity transmit data can be prevented by stopping issuing the transmit data request greater in DTC than the window value (win[p][rd_ptr]) held in the area indicated by the read pointer of the ring buffer corresponding to the low priority.

In other words, as long as the DTC required for the low-priority transmit data request does not exceed the window value, the input of the low-priority transmit data can be completed before the input of the transmit data based on the high-priority transmit data request is started, and the transfer of the low-priority transmit data therefore does not cause a delay in transfer of the high-priority transmit data.

By the way, it has been described that the data transfer device 30 of the present embodiment has a configuration in which the RTC measurement unit 38 and window control unit 39 are added to the data transfer device 30 of the above-described first embodiment but, for example, the DTC delay control unit 37 described in the first embodiment may be omitted.

However, if the DTC delay control unit 37 is omitted, the delay described in the above-described first embodiment may occur.

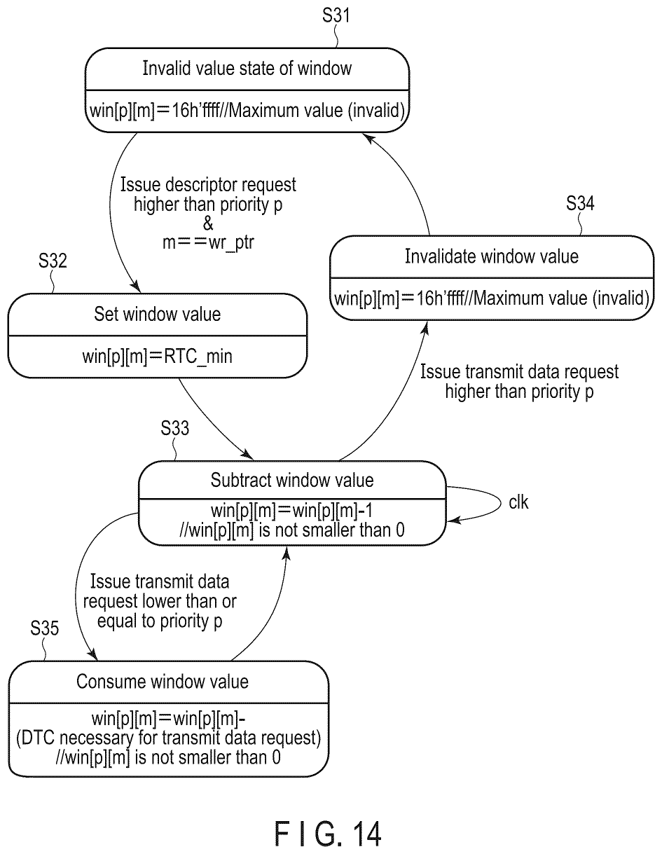

Therefore, when the DTC delay control unit 37 is omitted, the window control unit 39 may operate as shown in FIG. 14 to be described below. Incidentally, in FIG. 14, only the portions that differ from those in FIG. 12 described above will be described.

In the example shown in FIG. 14, the window control unit 39 executes processes in steps S31 to S34, which correspond to the processes in steps S21 to S24 shown in FIG. 12 described above, but executes the process in step S35 in addition to these processes.

More specifically, in the example shown in FIG. 12, the window control unit 39 simply subtracts win[p][m] in each clock cycle (i.e., decreases according to the clock cycle). In step S35 shown in FIG. 14, when the transmit data request is issued for the reason that the window value is larger than the DTC required for a transmit data request with a priority lower than or equal to the priority p as described above (i.e., the DTC calculated from the data length of the transmit data requested by the transmit data request), the window control unit 39 subtracts the DTC from the window value, then waits until the number of clock cycles corresponding to the DTC has elapsed, and returns to step S33 (i.e., resumes decreasing the window value after the number of clock cycles has elapsed). Incidentally, since the transmit data request with a priority lower than or equal to the priority p is issued when the window value is larger than the DTC required by the transmit data request, the window value cannot become smaller than 0 even if the process in step S35 is executed.

According to the operation of the window control unit 39 shown in FIG. 14, in a case where the low-priority transmit data request is issued, since the window value is consumed significantly based on the DTC required for the transmit data request, for example, it is possible to avoid further low-priority transmit data requests being issued until the number of clock cycles corresponding to the DTC elapses (i.e., while the window value is decreasing), and obtain the same effect as the configuration including the above-described DTC delay control unit 37.

According to the data transfer device 30 of the above-described present embodiment, it is possible to suppress giving an influence of the process of transferring the low-priority transmit data to the process of transferring the high-priority transmit data (i.e., to reduce the transfer delay for the high-priority transmit data), by limiting issuing the low-priority transmit data request later than the high-priority descriptor request, using the window value set at the timing at which the high-priority descriptor request is issued.

Incidentally, the data transfer device 30 of the present embodiment may be configured to set the attribute for each of the queues Q0 to QN described in the above-described first embodiment and to control whether or not to stop issuing the transmit data requests for each of the attributes.

As described in the first embodiment, for example, in IEEE 802.1Qbu/803.3br, since the MAC to which the queue is connected is classified into the attributes Preemptable and Express, only issuing the transmit data requests which require the transmit data stored in the queue connected to Preemptable that does not need to be transmitted with a comparatively low delay is considered to be stopped.

Incidentally, to realize such a configuration, the attribute discrimination table described in the above-described first embodiment may be held inside the data transfer device 30.

In addition, in the present embodiment, it has been described that the RTC (number of clock cycles) is set as the window value and that the window value is subtracted per clock cycle (i.e., decreased according to the elapse of clock cycles). However, the data length (data size) may be set as the window value. In this case, the window value may be subtracted by the data length (i.e., bus width) which can be transmitted (transferred) per clock cycle between the host side memory 20 and the data transfer device 30.

Although detailed descriptions are omitted, the time described in the above-described first embodiment may be set as the window value in the present embodiment.

### Third Embodiment

Next, a third embodiment will be described. The present embodiment is different from the first and second embodiments in that a specific implementation example of applying TSN to the communication device (data transfer device) described in the first and second embodiments is assumed.

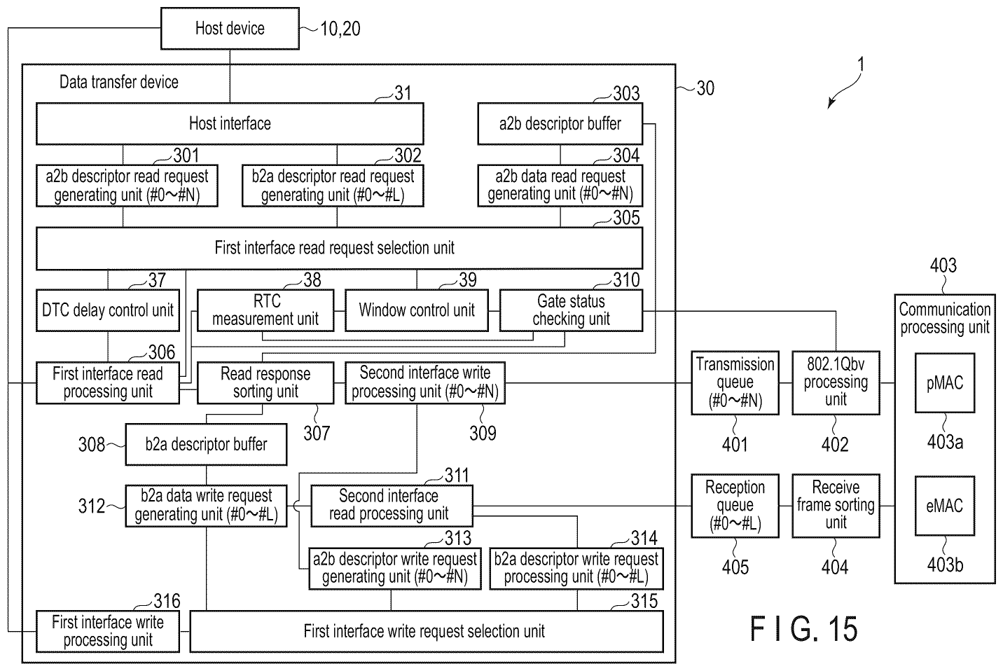

FIG. 15 shows an example of a configuration of a communication device in the present embodiment. In FIG. 15, the same portions as those in FIG. 5 and FIG. 10 will be denoted by the same reference numerals and their detailed descriptions will be omitted, and portions different from FIG. 5 and FIG. 10 will be mainly described.

In the present embodiment, a2b represents a process of transmitting data from the host device to the external device via the data transfer device 30, and b2a represents a process of receiving data from the external device by the host device via the data transfer device 30.

Incidentally, the host device shown in FIG. 15 comprises the CPU 10 and the host side memory 20 shown in FIG. 5 and FIG. 10. Although not shown in FIG. 15, an a2b data area, an a2b descriptor area, a b2a data area, and a b2a descriptor area are prepared in the host side memory 20. The a2b data area and the a2b descriptor area correspond to the above-described transmit data area 20a and descriptor area 20b shown in FIG. 5 and FIG. 10, respectively. The b2a data area is an area where data related to b2a (received data) is written, and the b2a descriptor area is an area where descriptors in which information on the received data is described are written.

In addition, in the present embodiment, the host interface 31 includes an a2b queues q0 to qN register area where descriptor information including a pointer indicative of the location of the a2b descriptor area in which the descriptor is written is stored, and a b2a queues q0 to qL register area where descriptor information including a pointer indicative of the location of the b2a descriptor area in which the descriptor is written is stored.

A a2b descriptor read request generating unit 301 generates a descriptor read request (i.e., a request including an address, a data length, and the like) necessary for accessing the host side memory 20, based on the descriptor information stored in the a2b queues q0 to qN register area in the host interface 31. Incidentally, the a2b descriptor read request generating unit 301 includes descriptor read request generating units #0 to #N corresponding to the above-described priorities (traffic classes).

A b2a descriptor read request generating unit 302 generates a descriptor read request (i.e., a request including an address and a data length) necessary for accessing the host side memory 20, based on the descriptor information stored in the plurality of b2a queues q0 to qL register areas in the host interface 31. Incidentally, the b2a descriptor read request generating unit 302 includes descriptor read request generating units #0 to #L corresponding to the priorities (traffic classes).

A functional unit related to a2b, such as the above-described a2b descriptor read request generating unit 301, includes functional units #0 to #N corresponding to the priority, and a functional unit related to b2a, such as the b2a descriptor read request generating unit 302, includes functional units #0 to #L corresponding to the priority. However, N and L in the present embodiment may be the same or different numbers.

An a2b descriptor buffer 303 corresponds to the descriptor buffer 34 described in the above-described first and second embodiments, and includes a2b queues q0 to qN corresponding to the priorities. The descriptors read from the host side memory 20 (a2b descriptor area) based on the descriptor read request generated by the a2b descriptor read request generating unit 301 are stored in the a2b queues q0 to qN.

An a2b data read request generating unit 304 generates a data read request (i.e., a request including an address and a data length) required to access the host side memory 20, based on the descriptors stored in the a2b descriptor buffer 303. Incidentally, the a2b data read request generating unit 304 includes data read request generating units #0 to #N corresponding to the above-described priorities.

The first interface read request selection unit 305 selects the request generated by the a2b descriptor read request generation unit 301, the b2a descriptor read request generating unit 302, and the a2b data read request generating unit 304, and passes the selected request to the first interface read processing unit 306, in accordance with the instructions from the DTC delay control unit 37 and the window control unit 39 described in the above-described first and second embodiments, Strict Priority, and the like.

The first interface read processing unit 306 accesses the host side memory 20 based on the request passed from the first interface read request selection unit 305 and inputs a response to the request. Incidentally, the access to the host side memory 20 made by the first interface read processing unit 306 is executed according to, for example, a predetermined protocol such as AXI4.

If the request passed from the first interface read request selection unit 305 is, for example, the descriptor read request generated by the a2b descriptor read request generating unit 301, the first interface read processing unit 306 inputs the descriptor read from the host side memory 20 (a2b descriptor area) based on the descriptor read request and passes the descriptor to a read response sorting unit 307.

If the request passed from the first interface read request selection unit 305 is, for example, the descriptor read request generated by the b2a descriptor read request generating unit 302, the first interface read processing unit 306 inputs the descriptor read from the host side memory 20 (b2a descriptor area) based on the descriptor read request and passes the descriptor to a read response sorting unit 307.

If the request passed from the first interface read request selection unit 305 is, for example, the data read request generated by the a2b data read request generating unit 304, the first interface read processing unit 306 inputs the transmit data read from the host side memory 20 (a2b data area) based on the data read request and passes the transmit data to a read response sorting unit 307.

The read response sorting unit 307 sorts the responses input (read) from the host side memory 20 by the first interface read processing unit 306.

The read response sorting unit 307 sorts the descriptors input from the a2b descriptor area into the a2b descriptor buffer 303. As a result, the descriptors input from the a2b descriptor area are stored in the a2b descriptor buffer 303.

The read response sorting unit 307 sorts the descriptors input from the b2a descriptor area into a b2a descriptor buffer 308. As a result, the descriptors input from the b2a descriptor area are stored in the b2a descriptor buffer 308. Incidentally, the b2a descriptor buffer 308 includes b2a queues q0 to qL corresponding to the priorities (traffic classes).

The read response sorting unit 307 sorts the transmit data input from the a2b data area to a second interface write processing unit 309. As a result, the transmit data input from the a2b data area is output from the second interface write processing unit 309 to a transmission queue 401 and written to the transmission queue 401. Incidentally, the second interface write processing unit 309 includes write processing units #0 to #N corresponding to the priorities (traffic classes).

Incidentally, it is assumed that the information for the read response sorting unit 307 to sort the responses from the host side memory 20 is obtained from the first interface read processing unit 306. For example, the order of issuing the requests, protocol information (response ID) for accessing the host side memory 20, and the like are used as the information for sorting the responses.

The transmission queue 401 corresponds to the transmission memory 40 for the NIC in the above-described first and second embodiments, and includes queues #0 to #N corresponding to the priorities (traffic classes).

An 802.1Qbv processing unit 402 executes processing of IEEE 802.1Qbv. More specifically, the 802.1Qbv processing unit 402 holds gate control information of IEEE 802.1Qbv and includes a gate driver. The gate control information is information that the open/close status of the gate of the transmission queue 401 (queues #0 to #N) where the transmit data is stored according to the priority (traffic class) is set. The gate driver controls the open/close process of the gate of the transmission queue 401 (queues #0 to #N) at the timing of setting in the gate control information. The transmission timing of each traffic class can be controlled at the scheduled timing.

A communication processing unit (802.1Qbu/802.13br processing unit) 403 executes Media Access Control (MAC) processing including processing of IEEE 802.1Qbu/IEEE 802.3br. More specifically, in the transmission processing, when transmit data (Express) is stored in a transmission queue for eMAC (not shown) while the transmission processing unit of a Preemptable Media Access Control (pMAC) 403a transmits transmit data (Preemptable) stored in a transmission queue for pMAC (not shown), by a 802.1Qbv processing unit, the communication processing unit 403 stops the processing of the pMAC 403a and interrupts a process of transmitting an express Media Access Control (eMAC) 403b. When the process of transmitting the eMAC 403b is completed, the communication processing unit 403 resumes the process of transmitting the pMAC 403a. The high-priority transmit data can be thereby transmitted with a low delay.

Incidentally, the communication device shown in FIG. 15 presents a specific implementation example in which the TSN is applied. For example, the first interface read request selection unit 305, the first interface read processing unit 306, and the read response sorting unit 307 shown in FIG. 15 correspond to the first interface unit 32 shown in FIG. 5 and FIG. 10. In addition, the a2b descriptor read request generating unit 301 shown in FIG. 15 corresponds to the descriptor read unit 33 shown in FIG. 5 and FIG. 10. In other words, the descriptor read request generated by the a2b descriptor read request generating unit 301 corresponds to the descriptor request described in the above-described first and second embodiments. Furthermore, the a2b descriptor buffer 303 shown in FIG. 15 corresponds to the descriptor buffer 34 shown in FIG. 5 and FIG. 10. In addition, the a2b data read request generating unit 304 shown in FIG. 15 corresponds to the transmit data read unit 35 shown in FIG. 5 and FIG. 10. In other words, the data read request generated by the a2b data read request generating unit 304 corresponds to the transmit data request described in the above-described first and second embodiments. Furthermore, the second interface write processing unit 309 shown in FIG. 15 corresponds to the second interface unit 36 shown in FIG. 5 and FIG. 10. In addition, the transmission queue 401 shown in FIG. 15 corresponds to the transmission memory 40 for NIC shown in FIG. 5 and FIG. 10, and the 802.1Qbv processing unit 402 and the communication processing unit 403 operate as parts of the NIC.

In addition, the data transfer device 30 provided in the communication device 1 of the present embodiment includes the DTC delay control unit 37, the RTC measurement unit 38, and the window control unit 39 described in the above-described first and second embodiments, but further includes a gate status checking unit 310 in addition to these units 37 to 39.

The gate status checking unit 310 checks the open/close status of the gate of the queue in which the transmit data is stored during a predetermined period after the transmit data is output to the transmission queue 401, based on the gate control information held in the 802.1Qbv processing unit 402, the RTC held inside the RTC measurement unit 38 (i.e., the measurement results of the RTC measurement unit 38), and the maximum value of the data length transferred by the data transfer device 30 (maximum data length of transmitted data).

Incidentally, in the present embodiment, the DTC delay control unit 37, the RTC measurement unit 38, and the window control unit 39 operate as described in the above-described first and second embodiments. The window value in the present embodiment is set (determined) based on the above-described checking result of the gate status checking unit 310.

By the way, the functional units on data transmission in the above-described first and second embodiments have been mainly described. In the communication device 1 shown in FIG. 15, a functional unit related to data reception is further provided. The functional unit related to the data reception will be briefly described below.

A receive frame sorting unit 404 sorts the data received by the communication processing unit 403 (hereinafter referred to as received data) into the queues #0 to #L in the reception queue 405. Incidentally, a plurality of queues #0 to #L in the reception queue 405 corresponds to priorities (traffic classes).

The second interface read processing unit 311 accesses the reception queue 405 and inputs (reads) the received data stored in the reception queue 405. Incidentally, the access to the reception queue 405 made by the second interface read processing unit 311 is executed according to, for example, a predetermined protocol such as AXI4. When the descriptor (descriptor of write destination) exists in the b2a descriptor buffer 308, the second interface read processing unit 311 is assumed to determine that an area (receive buffer) is secured in the host side memory 20 and to read (input) the received data.

A b2a data write request generating unit 312 generates a data write request (i.e., a request including an address and a data length) necessary to access the host side memory 20, based on the descriptor stored in the b2a descriptor buffer and the received data input by the second interface read processing unit 311. Incidentally, the b2a data write request generating unit 312 includes the data write request generating units #0 to #L corresponding to the priorities (traffic classes).

The a2b descriptor write request generating unit 313 generates a descriptor write request (i.e., a request including an address and a data length) to write the descriptor (e.g., to set a completion flag) on the host side memory 20 (a2b descriptor area) in order to notify that the transmit data has been output from the second interface write processing unit 309 (i.e., transmitting the transmit data is completed). Incidentally, the a2b descriptor write request generating unit 313 includes a plurality of descriptor write request generating units #0 to #N corresponding to the priorities (traffic classes).

The b2a descriptor write request processing unit 314 generates a descriptor write request (i.e., a request including an address and a data length) to rewrite the descriptor (for example, to set a completion flag) in the host side memory 20 (b2a descriptor area) to notify that a received frame is input by the second interface read processing unit 311 (i.e., receiving the received frame is completed). Incidentally, the b2a descriptor write request processing unit 314 includes descriptor write request processing units #0 to #L corresponding to the priorities (traffic classes).

A first interface write request selection unit 315 selects the request generated by the b2a data write request generating unit 312, the a2b descriptor write request generating unit 313, and the b2a descriptor write request processing unit 314 in accordance with, for example, Strict Priority and the like, and passes the selected request to a first interface write processing unit 316.

The first interface write processing unit 316 accesses the host side memory 20 based on the request passed from the first interface write request selection unit 315 and writes descriptors and received data based on the request. Incidentally, the access to the host side memory 20 made by the first interface write processing unit 316 is executed according to, for example, a predetermined protocol such as AXI4.

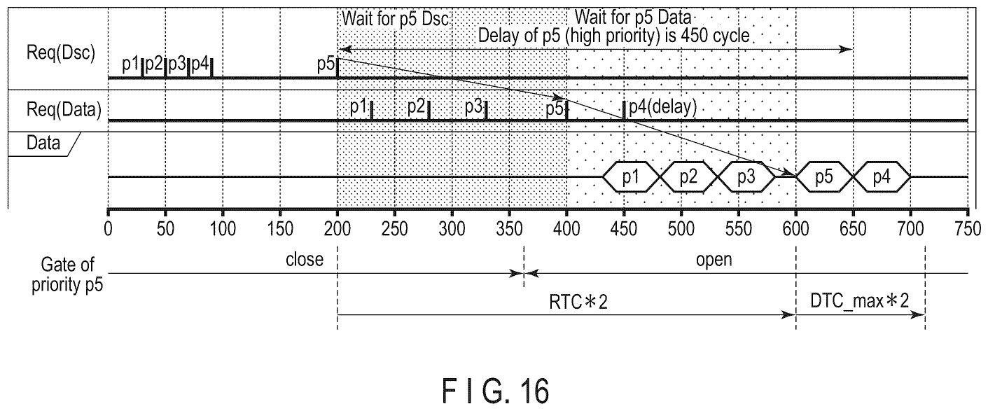

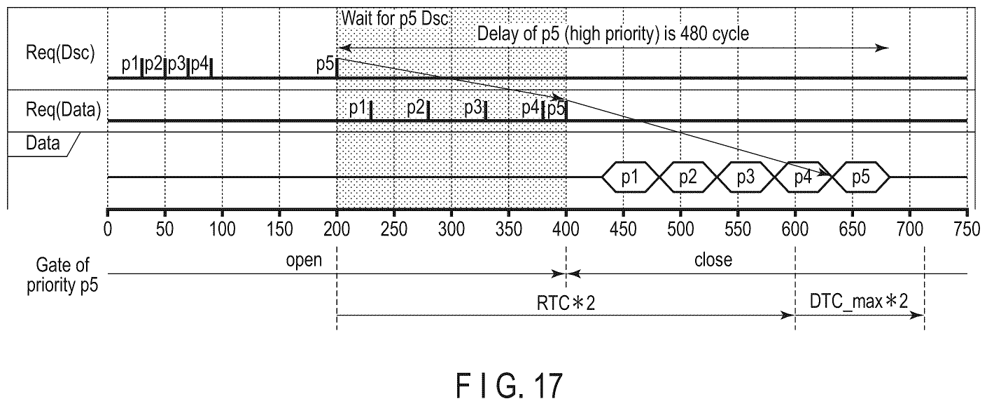

An example of the operation of the window control unit 39 and the gate state checking unit 310 in the present embodiment will be described with reference to FIG. 16 and FIG. 17. Similar to FIG. 9 and FIG. 13, FIG. 16 and FIG. 17 show a series of operations of the data transfer device 30 during transferring the transmit data of priorities p1 to p5.

As described in the above-described second embodiment, when the descriptor request (descriptor read request) p5 is issued after the descriptor requests (descriptor read requests) p1 to p4 are issued and when the priority p5 is higher than the priorities p1 to p4, the data transfer device 30 sets the window value at the timing when the descriptor request p5 is issued. According to this, as shown in FIG. 16, the input of the transmit data p5 to the data transfer device 30 is started in the 600-th clock cycle and completed in the 650-th clock cycle. The transmitted data p5 input to the data transfer device 30 in this manner is stored in the transmission queue 401, and the transfer of the transmitted data p5 from the host side memory 20 to the transmission queue 401 is completed.

In the present embodiment, however, the open/close status of the gate of the transmission queue 401 (queues #0 to #N) is controlled at the timing set in the gate control information as described above. Even if the transfer of the transmit data p5 is completed as described above, the transmit data p5 cannot be immediately transmitted unless a gate corresponding to the priority (traffic class) of the transmit data p5 (hereinafter referred to as a gate of transmit data p5) can be opened (an opened state). For this reason, even if the transfer of the transmit data request p4 is delayed as shown in FIG. 13, depending on the open/close status of the gate, the processing of the transmit data p5 cannot be executed immediately by the 802.1Qbv processing unit 402 and the delay processing of p4 becomes useless.

Therefore, the window value set when the descriptor request p5 is issued is determined by considering the above-described gate control information, in the present embodiment.

More specifically, referring to the gate control information, at the timing when the descriptor request p5 is issued, the gate status checking unit 310 checks whether the gate of the transmit data p5 is open at the shortest transfer start timing of the transmit data p5 when RTC*2 held inside the RTC measurement unit 38 elapses since the descriptor request p5 is issued (in other words, the timing when the input of the transmit data p5 to the data transfer device 30 and the transfer to the transmission queue 401 are started in the shortest time).

If the gate of the transmit data p5 at the above-described transfer start timing of the transmit data p5 is open, the gate status checking unit 310 checks whether the gate is continuously open during the period during which the transmission process of the transmit data p5 can be completed from the shortest transfer start timing.

By the way, since the descriptor p5 of the transmit data p5 is not input at the timing when the descriptor request p5 is issued as described above, the data transfer device 30 cannot recognize an exact data length of the transmit data p5 (i.e., the period required for the transmission process of the transmit data p5).

In this case, in the present embodiment, if the gate of the transmit data p5 is open during the period from the shortest transfer start timing of the transmit data p5 (i.e., the 600-th clock cycle shown in FIG. 16) to the maximum value of DTC (DTC_max)*2, the process of transmitting the transmit data p5 can be completed. Incidentally, DTC_max corresponds to the DTC calculated from the maximum value of the data length and the bus width transferred by the data transfer device 30.

Therefore, the gate status checking unit 310 checks whether or not the gate of the transmit data p5 is open during the period of DTC_max*2 from the above-described minimum transfer start timing of the transmit data p5 (i.e., 600-th clock cycle shown in FIG. 16).

According to this, if the gate status checking unit 310 checks that the gate of the transmit data p5 is open during the period of DTC_max*2 from the shortest transfer start timing, as shown in FIG. 16, it can be recognized that the transmit data p5 can be transmitted without delay by starting the transfer of the transmit data p5 in the 600-th clock cycle. In this case, the window control unit 39 sets the RTC held inside the RTC measurement unit 38 as the window value as described in the second embodiment.

In contrast, as shown in FIG. 17, if the gate status checking unit 310 checks that the gate of the transmit data p5 at the shortest transfer start timing is not open (i.e., the gate is not open during the DTC_max*2 period from the shortest transfer start timing), it is recognized that the transmit data p5 cannot be transmitted by the fact that the gate of the transmit data p5 is closed, even if the transfer of the transmit data p5 is started in the 600-th clock cycle. In this case, the gate status checking unit 310 checks C_nextopen, which corresponds to the period (number of clock cycles) from the time of the shortest transfer timing until the gate of the next transmit data p5 becomes open, by referring to the gate control information. The window control unit 39 sets a value calculated from the RTC held inside the RTC measurement unit 38, the C_nextopen and the DTC_max, as the window value. More specifically, the unit sets a value obtained by subtracting DTC_max from C_nextopen as a window correction value G, sets RTC+G as the window value if G is greater than or equal to 0, and sets RTC as the window value if G is smaller than 0. Although not shown in FIG. 17, according to such a window value, the transmit data request (data read request) can be issued such that the transmission of the transmit data p5 is started at the timing when the gate is next open.

As described above, the data transfer device 30 of the present embodiment checks the open/close status of the gate during a predetermined period (for example, DTC_max*2) from the shortest transfer start timing (i.e., the shortest timing when the second data is output to the second memory), based on the gate control information, the RTC (i.e., the measurement result) held inside the RTC measurement unit 38, and DTC_max (i.e., the maximum value of the transferred data length), and sets the window value based on the check results.

In the present embodiment, by setting the window value in consideration of the gate control information as described above, for example, it is possible to avoid a situation where issuing the low-priority transmit data request is stopped, for the high-priority transmit data that may cause a delay in the transmission process of the latter stage of the data transfer device 30 (i.e., the NIC), and to implement the process of efficiently transferring the transmit data.

Incidentally, it has been described that DTC_max is used to check the open/close status of the gate during the predetermined period from the transfer start timing, in the present embodiment. The present embodiment may be configured to check the open/close status of the gate during an estimated period when transmission of the transmit data can be completed, and the open/close status of the gate in a period different from the DTC_max*2 period may be checked.

As another configuration of the gate status checking unit 310, window corrected values G0 to GP of each of the priorities 0 to P may be calculated at any time, based on the gate control information held in the 802.1Qbv processing unit 402, the RTC held inside the RTC measurement unit 38 (i.e., the measurement result of the RTC measurement unit 38), and the maximum value of the data length transferred by the data transfer device 30 (the value may be set individually for each maximum data length of the transmit data and priority). The equation of each of G0 to GP is the same as the above-described method. In this case, the window control unit 39 sets the value obtained by adding Gp (p=0 to P) and RTC of the priority when setting the above-described window value, as the window value.

In addition, the gate status checking unit 310 may also hold information equivalent to the gate control information held in the 802.1Qbv processing unit 402 inside the unit. In this case, the gate state checking unit 310 always refers to the status in the RTC*2 future gate rather than the time referenced by the 802.1Qbv processing unit 402.

According to at least one embodiment described above, the data transfer device and method capable of implementing a low delay in communication can be provided.

### Example of System Configuration

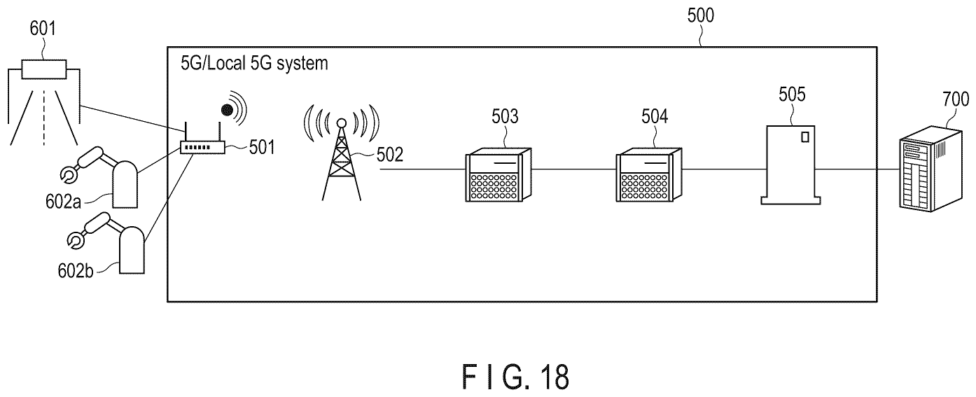

FIG. 18 is a diagram showing a configuration example of a system using the communication device 1 according to each of the above-described embodiments. FIG. 18 shows an example of controlling a belt conveyor 601 and robot arms 602a and 602b at a site from an edge server 700 via a 5th Generation (5G)/local 5G system 500 in a factory or plant.

The 5G/local 5G system 500 comprises a 5G core network 505, a central unit 504, a distributed unit 503, a remote unit 502, and user equipment 501. The 5G/local 5G system 500 executes 5G communication defined under 3rd Generation Partnership Project (3GPP) (registered trademark) standards.

The communication device 100 in each embodiment can be mounted on, for example, an edge server 700 or a 5G core network 505. The real-time performance of the communication between the edge server 700 and the 5G core network 505 can be thereby improved.

In addition, the communication device 1 in each embodiment may be used for communication between the units in the 5G/local 5G system 500. In other words, to execute communication between the remote unit 502, the distributed unit 503, the central unit 504, and the 5G core network 505, the communication device 1 in each embodiment may be mounted on at least some of the remote unit 502, the distributed unit 503, the central unit 504, and the 5G core network 505.

The communication device 1 in each embodiment may be used for communication between at least one of the belt conveyor 601 and robot arms 602a and 602b, and the user equipment 501 or communication between the belt conveyor 601 and the robot arms 602a and 602b.

The system to which the communication device 1 in each embodiment can be applied is not limited to this, but can be any system. For example, the system can also be applied to industrial network systems in factories or plants that do not use 5G/local 5G, network systems inside vehicles and aircraft, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data transfer device configured to sequentially transfer data with specified priority, the device comprising:
an issuing unit configured to issue a first request to transfer first data via the first interface; and
a controller configured to stop issuing a second request to transfer second data after the first data, while a period required after an input of a response to the first request via the first interface is started and until the input is completed elapses, when the first request is issued.

2. The data transfer device of claim 1, wherein
the issuing unit is configured, if issuing a third request to transfer third data after the second data is enabled when suspension of issuing the second request is canceled, to issue the second or third request based on a priority specified for the second and third data.

3. The data transfer device of claim 2, wherein
the first to third requests are requests to request the first to third data.

4. The data transfer device of claim 2, wherein
the first to third requests are requests to request first to third descriptors in which information on the first to third data is described.

5. The data transfer device of claim 1, wherein
the controller is configured to stop issuing the second request when a specified priority to the second data is lower than a predetermined priority.

6. The data transfer device of claim 1, wherein
the data transfer device is connected to a first memory via the first interface, and
the first data is input from the first memory via the first interface, and output to a second memory different from the first memory via a second interface different from the first interface.

7. The data transfer device of claim 6, wherein
the first data output to the second memory is transmitted via a network device for connecting to a network.

8. A data transfer device configured to sequentially transfer data with specified priority, the device comprising:
a first issuing unit configured to issue a first descriptor request requesting a first descriptor in which information on first data is described;
a second issuing unit configured to issue a first data request requesting the first data, based on a first descriptor input by issuing the first descriptor request; and
a first controller configured to set a window value at timing when a second descriptor request is issued and to decrease the window value according to elapse of a clock cycle or time, the second descriptor request being requesting a second descriptor in which information on second data with a priority higher than the first data is described, wherein
the second issuing unit is configured to issue the first data request, based on a period required after an input of the first data is started and until the input is completed, and the window value.

9. The data transfer device of claim 8, further comprising:
a second controller configured to stop issuing the second descriptor request while a period required after an input of the first descriptor is started and until the input is completed elapses in a case where the first descriptor request is issued, or to stop issuing the second data request requesting the second data while a period required after an input of the first data is started and until the input is completed elapses in a case where the first data request is issued.

10. The data transfer device of claim 8, wherein
the first controller is configured, when the first data request is issued, to subtract a period required after an input of the first data is started and until the input is completed, from the window value and to resume decrease of the window value after the period elapses.

11. The data transfer device of claim 8, further comprising:
a measurement unit configured to measure a period elapsing after a third descriptor request before the first descriptor request is issued and until an input of a third descriptor requested by the third descriptor request is started or a period elapsing after a third data request before the first data request is issued and until an input of third data requested by the third data request is started, wherein
the window value is determined based on the measurement result.

12. The data transfer device of claim 11, wherein
the data transfer device is connected to a first memory via the first interface, and
the first data is input from the first memory via the first interface, and output to a second memory different from the first memory via a second interface different from the first interface.

13. The data transfer device of claim 12, wherein
the first data output to the second memory is transmitted via a network device for connecting to a network.

14. The data transfer device of claim 13, wherein
the network device conforms to IEEE802.1Qbu/3br, and
the second issuing unit is configured to issue the first data request, based on the window value only when the first data is a Preemptable frame in the IEEE802.1Qbu/3br.

15. The data transfer device of claim 13, further comprising:
a checking unit, wherein
the second memory includes a plurality of queues,
the network device is configured to control transmission timing of the data, based on gate control information indicative of open/close status of a gate of the queue in which the data is stored, the open/close status of the gate being set according to a priority specified for data transmitted from the network,
the checking unit is configured to check an open/close status of a gate of a queue in which the second data is stored in a period elapsing after the second data is output to the second memory, based on the gate control information, the measurement result, and a maximum value of the transferred data length, and
the window value is set based on the check result.

16. A method executed by a data transfer device configured to sequentially transfer data with specified priority, the method comprising:
issuing a first request to transfer first data via the first interface; and
stopping issuing a second request to transfer second data after the first data, while a period required after an input of a response to the first request via the first interface is started and until the input is completed elapses, when the first request is issued.

17. A method executed by a data transfer device configured to sequentially transfer data with specified priority, the method comprising:
issuing a first descriptor request requiring a first descriptor in which information on first data is described;
issuing a first data request requesting the first data, based on a first descriptor input by issuing the first descriptor request; and
setting a window value at timing when a second descriptor request is issued and decreasing the window value according to elapse of a clock cycle or time, the second descriptor request being requesting a second descriptor in which information on second data with a priority higher than the first data is described, wherein
the issuing the first data request includes issuing the first data request, based on a period required after an input of the first data is started and until the input is completed, and the window value.
